(19) United States
(12) Patent Application Publication
(10) Pub. No.: US 2018/0240458 A1
(43) Pub. Date: Aug. 23, 2018

(54) WEARABLE APPARATUS AND METHOD FOR VOCABULARY MEASUREMENT AND ENRICHMENT

(71) Applicant: Ron Zass, Kiryat Tivon (IL)

(72) Inventor: Ron Zass, Kiryat Tivon (IL)

(21) Appl. No.: 15/437,031

(22) Filed: Feb. 20, 2017

(51) Int. Cl. G10L 15/22; G10L 21/028; G10L 15/18

(52) U.S. Cl. CPC G10L 15/22; G10L 2015/088; G10L 15/1815; G10L 21/028

(57) ABSTRACT

A method and a system for analyzing audio data are provided. The audio data may be analyzed to identify speaker vocabulary. The audio data may be analyzed to identify one or more words associated with a speaker. One or more vocabulary records may be updated based on the one or more words. Feedbacks and reports may be provided based on the one or more vocabulary records.

### BACKGROUND

### Technological Field

The disclosed embodiments generally relate to an apparatus and method for processing audio. More particularly, the disclosed embodiments relate to apparatus and method for vocabulary measurement and vocabulary enrichment.

### Background Information

Audio sensors are now part of numerous devices, from intelligent personal assistant devices to mobile phones, and the availability of audio data produced by these devices is increasing.

Vocabulary is an important tool in communication. Measuring the vocabulary size of a person may be used in the evaluation of language skills, language development, and communication disorders. Expanding vocabulary size of a person may improve the person communication abilities. This may be true both for language native speakers, and for people learning a second language.

### SUMMARY

In some embodiments, a method and a system for analyzing audio data to identify speaker vocabulary are provided. Audio data captured by audio sensors may be obtained. The audio data may be analyzed to identify one or more words associated with a speaker. One or more vocabulary records may be updated based on the one or more words. Feedbacks and reports may be provided based on the one or more vocabulary records.

### BRIEF DESCRIPTION OF THE DRAWINGS

FIGS. 1A, 1B, 1C, 1D, 1E and 1F are schematic illustrations of some examples of a user wearing a wearable apparatus.

FIGS. 2 and 3 are block diagrams illustrating some possible implementation of a communication system.

FIGS. 4A and 4B are block diagrams illustrating some possible implementation of an apparatus.

FIG. 5 is a block diagram illustrating a possible implementation of a server.

FIGS. 6A and 6B are block diagrams illustrating some possible implementation of a cloud platform.

FIG. 7 is a block diagram illustrating a possible implementation of a computational node.

FIG. 8 illustrates an example of a process for obtaining and/or analyzing audio data.

FIG. 9 illustrates an example of a process for obtaining and/or analyzing motion data.

FIG. 10 illustrates an example of a process for obtaining and/or analyzing physiological data.

FIG. 11 illustrates an example of a process for obtaining and/or analyzing positioning data.

FIG. 12 illustrates an example of a process for analyzing audio data to obtain textual information.

FIG. 13 illustrates an example of a process for identifying conversations.

FIG. 14 illustrates an example of a process for identifying speakers.

FIG. 15 illustrates an example of a process for identifying context.

FIG. 16 illustrates an example of a process for analyzing audio to update vocabulary records.

### DESCRIPTION

Unless specifically stated otherwise, as apparent from the following discussions, it is appreciated that throughout the specification discussions utilizing terms such as “processing”, “calculating”, “computing”, “determining”, “assessing”, “analyzing”, “generating”, “setting”, “configuring”, “selecting”, “defining”, “updating”, “applying”, “obtaining”, “providing”, or the like, include action and/or processes of a computer that manipulate and/or transform data into other data, said data represented as physical quantities, for example such as electronic quantities, and/or said data representing the physical objects. The terms “computer”, “processor”, “controller”, “processing unit”, and “computing unit” should be expansively construed to cover any kind of electronic device, component or unit with data processing capabilities, including, by way of non-limiting example, a personal computer, a wearable computer, a tablet, a smartphone, a server, a computing system, a communication device, a processor (for example, digital signal processor (DSP), and possibly with embedded memory, a microcontroller, a field programmable gate array (FPGA), an application specific integrated circuit (ASIC), a graphics processing unit (GPU), and so on), a core within a processor, any other electronic computing device, and or any combination of the above.

The operations in accordance with the teachings herein may be performed by a computer specially constructed and/or programmed to perform the described functions.

As used herein, the phrase “for example”, “such as”, “for instance”, “in some examples”, and variants thereof describe non-limiting embodiments of the presently disclosed subject matter. Reference in the specification to “one case”, “some cases”, “other cases” or variants thereof means that a particular feature, structure or characteristic described in connection with the embodiment(s) may be included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

It should be noted that some examples of the presently disclosed subject matter are not limited in application to the details of construction and the arrangement of the components set forth in the following description or illustrated in the drawings. The invention can be capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing may have the same use and description as in the previous drawings.

The drawings in this document may not be to any scale. Different figures may use different scales and different scales can be used even within the same drawing, for example different scales for different views of the same object or different scales for the two adjacent objects.

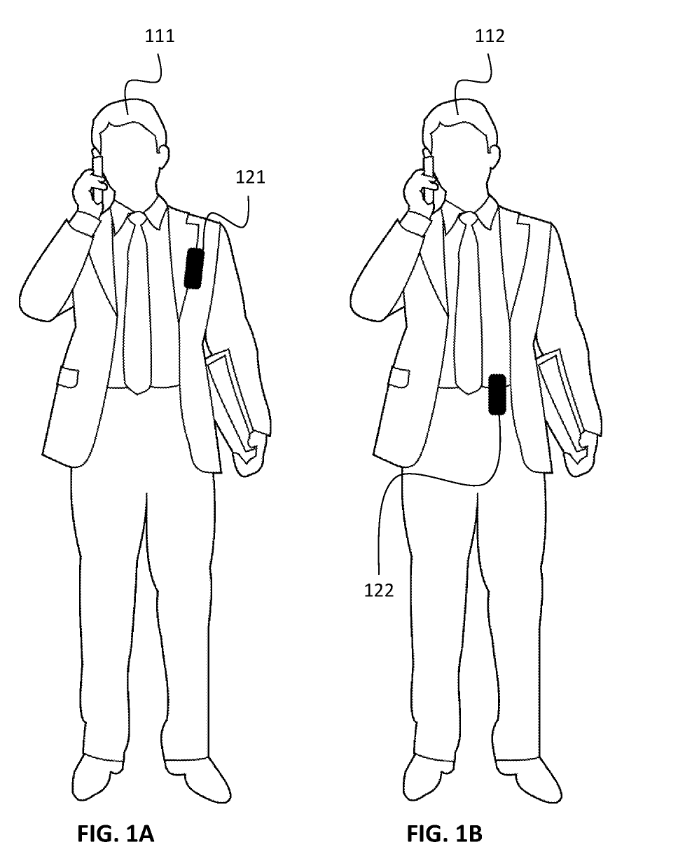

FIG. 1A is a schematic illustration of an example of user 111 wearing wearable apparatus or a part of a wearable apparatus 121. In this example, wearable apparatus or a part of a wearable apparatus 121 may be physically connected or integral to a garment, and user 111 may wear the garment.

FIG. 1B is a schematic illustration of an example of user 112 wearing wearable apparatus or a part of a wearable apparatus 122. In this example, wearable apparatus or a part of a wearable apparatus 122 may be physically connected or integral to a belt, and user 112 may wear the belt.

FIG. 1C is a schematic illustration of an example of user 113 wearing wearable apparatus or a part of a wearable apparatus 123. In this example, wearable apparatus or a part of a wearable apparatus 123 may be physically connected or integral to a wrist strap, and user 113 may wear the wrist strap.

FIG. 1D is a schematic illustration of an example of user 114 wearing wearable apparatus or a part of a wearable apparatus 124. In this example, wearable apparatus or a part of a wearable apparatus 124 may be physically connected or integral to a necklace 134, and user 114 may wear necklace 134.

FIG. 1E is a schematic illustration of an example of user 115 wearing wearable apparatus or a part of a wearable apparatus 121, wearable apparatus or a part of a wearable apparatus 122, and wearable apparatus or a part of a wearable apparatus 125. In this example, wearable apparatus or a part of a wearable apparatus 122 may be physically connected or integral to a belt, and user 115 may wear the belt. In this example, wearable apparatus or a part of a wearable apparatus 121 and wearable apparatus or a part of a wearable apparatus 125 may be physically connected or integral to a garment, and user 115 may wear the garment.

FIG. 1F is a schematic illustration of an example of user 116 wearing wearable apparatus or a part of a wearable apparatus 126. In this example, wearable apparatus or a part of a wearable apparatus 126 may be physically connected to an ear of user 116. In some examples, wearable apparatus or a part of a wearable apparatus 126 may be physically connected to the left ear and/or right ear of user 116. In some examples, user 116 may wear two wearable apparatuses 126, where one wearable apparatus 126 may be connected to the left ear of user 116, and the second wearable apparatus 126 may be connected to the right ear of user 116. In some examples, user 116 may wear a wearable apparatus 126 that has at least two separate parts, where one part of wearable apparatus 126 may be connected to the left ear of user 116, and the second part of wearable apparatus 126 may be connected to the right ear of user 116.

In some embodiments, a user may wear one or more wearable apparatuses, such as one or more instances of wearable apparatuses 121, 122, 123, 124, 125, and/or 126. For example, a user may wear one or more wearable apparatuses that are physically connected or integral to a garment of the user, such as wearable apparatus 121 and/or wearable apparatus 125. For example, a user may wear one or more wearable apparatuses that are physically connected or integral to a belt of the user, such as wearable apparatus 122. For example, a user may wear one or more wearable apparatuses that are physically connected or integral to a wrist strap of the user, such as wearable apparatus 123. For example, a user may wear one or more wearable apparatuses that are physically connected or integral to a necklace that the user is wearing, such as wearable apparatus 124. For example, a user may wear one or more wearable apparatuses that are physically connected or integral to the left ear and/or right ear of the user, such as wearable apparatus 126. In some examples, the one or more wearable apparatuses may communicate and/or collaborate with one another. For example, the one or more wearable apparatuses may communicate by wires and/or wirelessly.

In some embodiments, a user may wear a wearable apparatus, and the wearable apparatus may comprise two or more separate parts. For example, the wearable apparatus may comprise parts 121, 122, 123, 124, 125, and/or 126. For example, the wearable apparatus may comprise one or more parts that are physically connected or integral to a garment of the user, such as 121 and/or part 125. For example, the wearable apparatus may comprise one or more parts that are physically connected or integral to a belt of the user, such as part 122. For example, the wearable apparatus may comprise one or more parts that are physically connected or integral to a wrist strap that the user is wearing, such as part 123. For example, the wearable apparatus may comprise one or more parts that are physically connected or integral to a necklace that the user is wearing, such as part 124. For example, the wearable apparatus may comprise one or more parts that are physically connected to the left ear and/or the right ear of the user, such as part 126. In some examples, the separate parts of the wearable apparatus may communicate by wires and/or wirelessly.

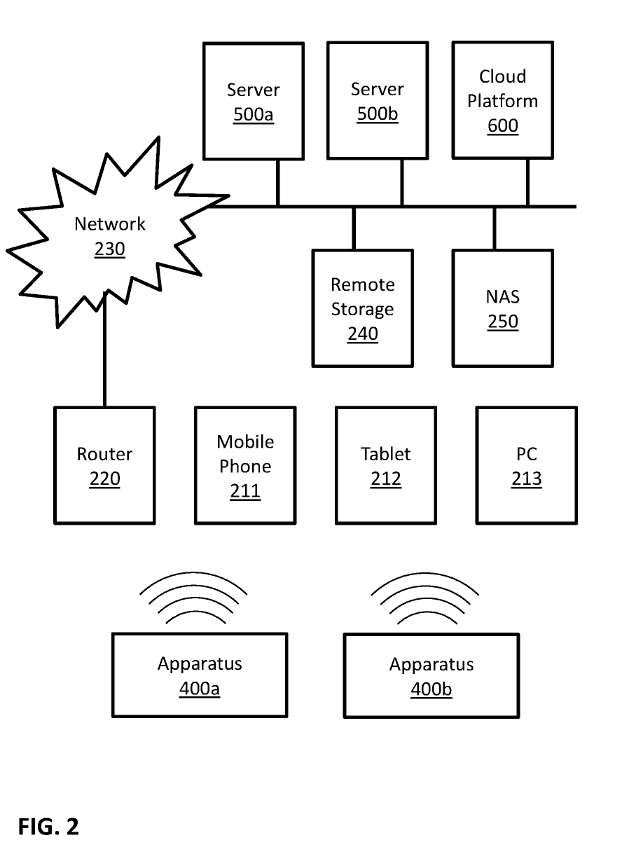

In some embodiments, possible implementations of wearable apparatuses 121, 122, 123, 124, 125, and/or 126 may include apparatus 400, for example as described in FIG. 4A and/or FIG. 4B. In some embodiments, apparatus 400 may comprise two or more separate parts. For example, apparatus 400 may comprise parts 121, 122, 123, 124, 125, and/or 126. In some examples, the separate parts may communicate by wires and/or wirelessly.

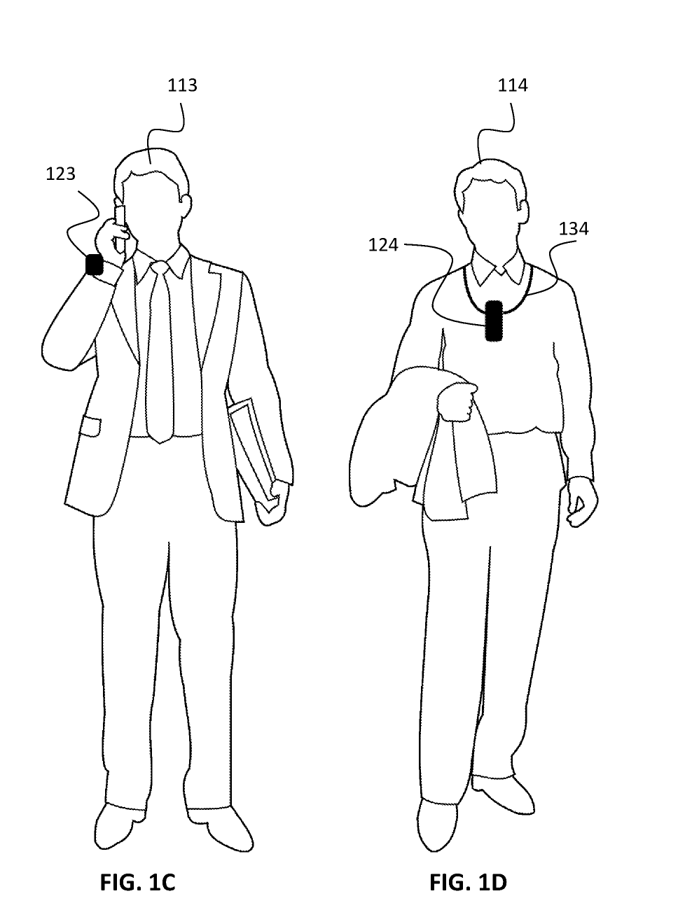

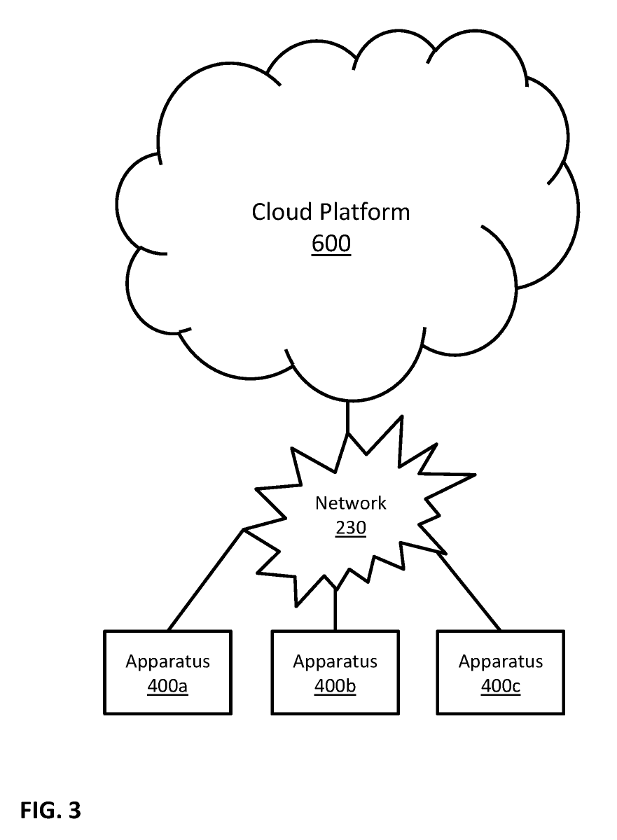

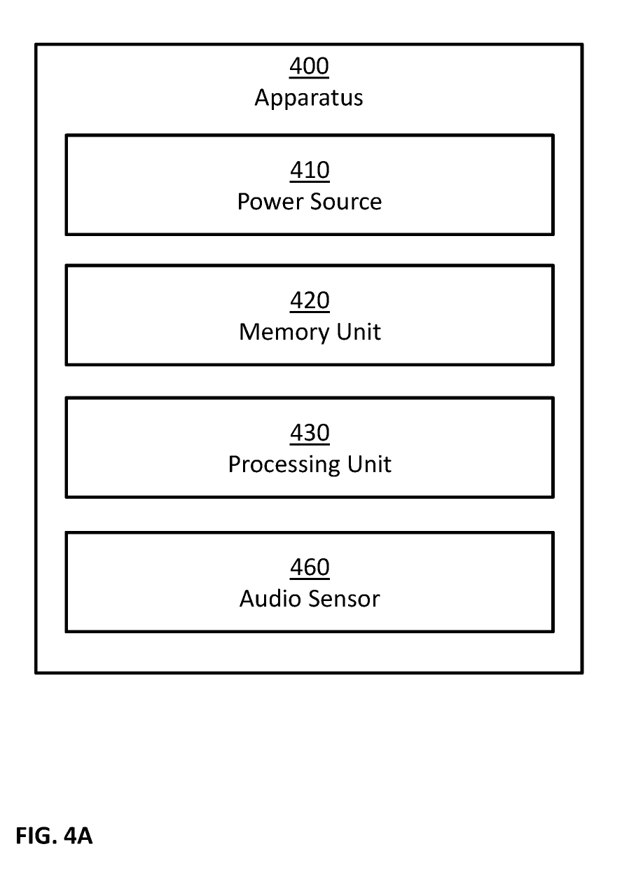

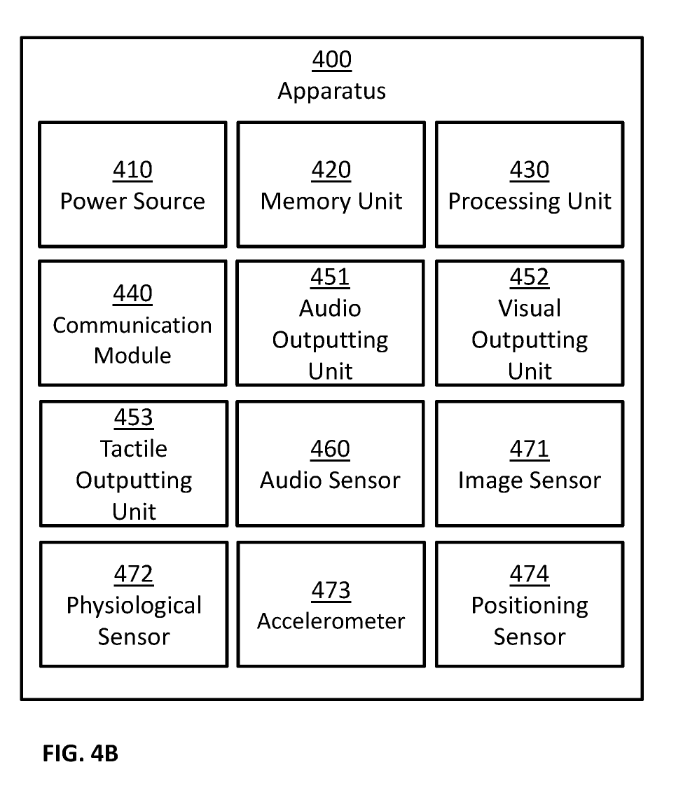

FIG. 2 is a block diagram illustrating a possible implementation of a communicating system. In this example, apparatuses 400a and 400b may communicate with server 500a, with server 500b, with cloud platform 600, with each other, and so forth. Some possible implementations of apparatuses 400a and 400b may include apparatus 400, for example as described in FIG. 4A and/or FIG. 4B. Some possible implementations of servers 500a and/or 500b may include server 500, for example as described in FIG. 5. Some possible implementations of cloud platform 600 are described in FIGS. 6A, 6B and 7. In this example, apparatus 400a and/or apparatus 400b may communicate directly with mobile phone 211, tablet 212, and/or personal computer (PC) 213. Apparatus 400a and/or apparatus 400b may communicate with local router 220 directly, and/or through at least one of mobile phone 211, tablet 212, and/or personal computer (PC) 213. In this example, local router 220 may be connected to communication network 230. Some examples of communication network 230 may include the Internet, phone networks, cellular networks, satellite communication networks, private communication networks, virtual private networks (VPN), and so forth. Apparatus 400a and/or apparatus 400b may connect to communication network 230 through local router 220 and/or directly. Apparatus 400a and/or apparatus 400b may communicate with other devices, such as servers 500a, server 500b, cloud platform 600, remote storage 240 and network attached storage (NAS) 250, and so forth, through communication network 230 and/or directly.

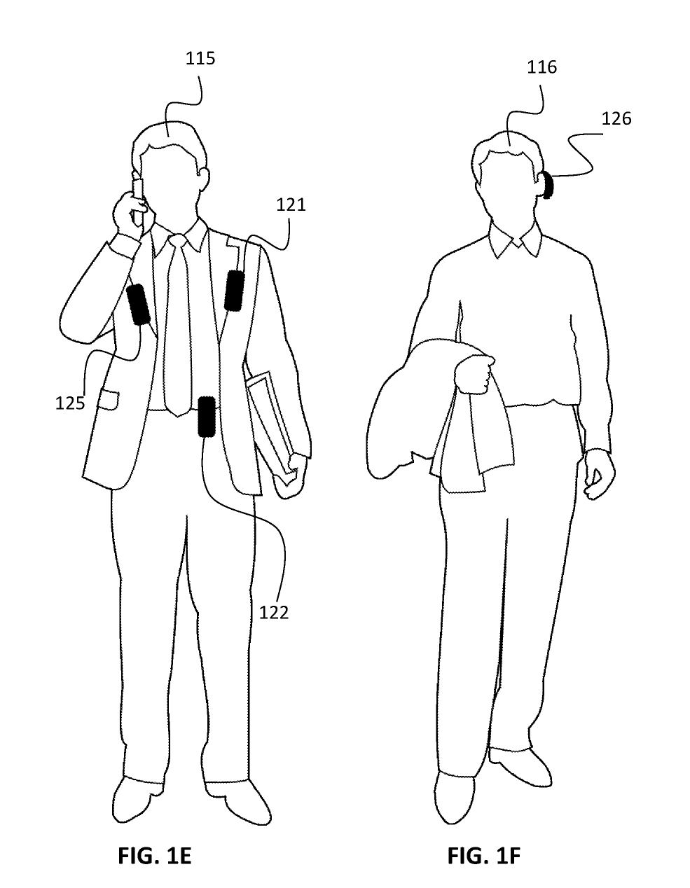

FIG. 3 is a block diagram illustrating a possible implementation of a communicating system. In this example, apparatus 400a, apparatus 400b and/or apparatus 400c may communicate with cloud platform 600 and/or with each other through communication network 230. Possible implementations of apparatuses 400a, 400b and 400c may include apparatus 400, for example as described in FIG. 4A and/or FIG. 4B. Some possible implementations of cloud platform 600 are described in FIGS. 6A, 6B and 7. Some examples of communication network 230 may include the Internet, phone networks, cellular networks, satellite communication networks, private communication networks, virtual private networks (VPN), and so forth.

FIGS. 2 and 3 illustrate some possible implementations of a communication system. In some embodiments, other communication systems that enable communication between apparatus 400 and server 500 may be used. In some embodiments, other communication systems that enable communication between apparatus 400 and cloud platform 600 may be used. In some embodiments, other communication systems that enable communication among a plurality of apparatuses 400 may be used.

FIG. 4A is a block diagram illustrating a possible implementation of apparatus 400. In this example, apparatus 400 comprises: one or more power sources 410; one or more memory units 420; one or more processing units 430; and one or more audio sensors 460. In some implementations additional components may be included in apparatus 400, while some components listed above may be excluded. In some embodiments, power sources 410 and/or audio sensors 460 may be excluded from the implementation of apparatus 400. In some embodiments, apparatus 400 may further comprise one or more of the followings: one or more communication modules 440; one or more audio output units 451; one or more visual outputting units 452; one or more tactile outputting units 453; one or more image sensors 471; one or more physiological sensors 472; one or more accelerometers 473; one or more positioning sensors 474; one or more chemical sensors; one or more temperature sensors; one or more barometers; one or more environmental sensors; one or more pressure sensors; one or more proximity sensors; one or more electrical impedance sensors; one or more electrical voltage sensors; one or more electrical current sensors; one or more clocks; one or more user input devices; one or more keyboards; one or more mouses; one or more touch pads; one or more touch screens; one or more antennas; one or more output devices; one or more audio speakers; one or more display screens; one or more augmented reality display systems; one or more LED indicators; and so forth.

FIG. 4B is a block diagram illustrating a possible implementation of apparatus 400. In this example, apparatus 400 comprises: one or more power sources 410; one or more memory units 420; one or more processing units 430; one or more communication modules 440; one or more audio output units 451; one or more visual outputting units 452; one or more tactile outputting units 453; one or more audio sensors 460; one or more image sensors 471; one or more physiological sensors 472; one or more accelerometers 473; and one or more positioning sensors 474. In some implementations additional components may be included in apparatus 400, while some components listed above may be excluded. In some embodiments, one or more of the followings may be excluded from the implementation of apparatus 400: power sources 410; communication modules 440; audio output units 451; visual outputting units 452; tactile outputting units 453; audio sensors 460; image sensors 471; physiological sensors 472; accelerometers 473; and positioning sensors 474. In some embodiments, apparatus 400 may further comprise one or more of the followings: one or more chemical sensors; one or more temperature sensors; one or more barometers; one or more environmental sensors; one or more pressure sensors; one or more proximity sensors; one or more electrical impedance sensors; one or more electrical voltage sensors; one or more electrical current sensors; one or more clocks; one or more user input devices; one or more keyboards; one or more mouses; one or more touch pads; one or more touch screens; one or more antennas; one or more output devices; one or more audio speakers; one or more display screens; one or more augmented reality display systems; one or more LED indicators; and so forth.

In some embodiments, the one or more power sources 410 may be configured to: power apparatus 400; power server 500; power cloud platform 600; power computational node 610; and so forth. Some possible implementation examples the one or more power sources 410 may comprise: one or more electric batteries; one or more capacitors; one or more connections to external power sources; one or more power convertors; one or more electric power generators; any combination of the above; and so forth.

In some embodiments, the one or more processing units 430 may be configured to execute software programs, for example software programs stored in the one or more memory units 420, software programs received through the one or more communication modules 440, and so forth. Some possible implementation examples of processing units 430 may comprise: one or more single core processors; one or more multicore processors; one or more controllers; one or more application processors; one or more system on a chip processors; one or more central processing units; one or more graphical processing units; one or more neural processing units; any combination of the above; and so forth. In some examples, the executed software programs may store information in memory units 420. In some cases, the executed software programs may retrieve information from memory units 420.

In some embodiments, the one or more communication modules 440 may be configured to receive and/or transmit information. Some possible implementation examples of communication modules 440 may comprise: wired communication devices; wireless communication devices; optical communication devices; electrical communication devices; radio communication devices; sonic and/or ultrasonic communication devices; electromagnetic induction communication devices; infrared communication devices; transmitters; receivers; transmitting and receiving devices; modems; network interfaces; wireless USB communication devices, wireless LAN communication devices; Wi-Fi communication devices; LAN communication devices; USB communication devices; firewire communication devices; bluetooth communication devices; cellular communication devices, such as GSM, CDMA, GPRS, W-CDMA, EDGE, CDMA2000, etc.; satellite communication devices; and so forth.

In some implementations, control signals and/or synchronization signals may be transmitted and/or received through communication modules 440. In some implementations, information received though communication modules 440 may be stored in memory units 420. In some implementations, information retrieved from memory units 420 may be transmitted using communication modules 440. In some implementations, input and/or user input may be transmitted and/or received through communication modules 440. In some implementations, audio data may be transmitted and/or received through communication modules 440, such as audio data captured using audio sensors 460. In some implementations, visual data, such as images and/or videos, may be transmitted and/or received through communication modules 440, such as images and/or videos captured using image sensors 471. In some implementations, physiological data may be transmitted and/or received through communication modules 440, such as physiological data captured using physiological sensors 472. In some implementations, proper acceleration information may be transmitted and/or received through communication modules 440, such as proper acceleration information captured using accelerometers 473. In some implementations, positioning information may be transmitted and/or received through communication modules 440, such as positioning information captured using positioning sensors 474.

In some implementations, output information may be transmitted and/or received through communication modules 440. In some implementations, audio output information may be transmitted and/or received through communication modules 440. For example, audio output information to be outputted using audio outputting units 451 may be received through communication modules 440. In some implementations, visual output information may be transmitted and/or received through communication modules 440. For example, visual output information to be outputted using visual outputting units 452 may be received through communication modules 440. In some implementations, tactile output information may be transmitted and/or received through communication modules 440. For example, tactile output information to be outputted using tactile outputting units 453 may be received through communication modules 440.

In some embodiments, the one or more audio outputting units 451 may be configured to output audio to a user, for example through a headset, through one or more audio speakers, and so forth. In some embodiments, the one or more visual outputting units 452 may be configured to output visual information to a user, for example through a display screen, through an augmented reality display system, through a printer, through LED indicators, and so forth. In some embodiments, the one or more tactile outputting units 453 may be configured to output tactile feedbacks to a user, for example through vibrations, through motions, by applying forces, and so forth. In some examples, output may be provided: in real time; offline; automatically; periodically; upon request; and so forth. In some examples, apparatus 400 may be a wearable apparatus and the output may be provided to: a wearer of the wearable apparatus; a caregiver of the wearer of the wearable apparatus; and so forth. In some examples, the output may be provided to: a caregiver; clinicians; insurers; and so forth.

In some embodiments, the one or more audio sensors 460 may be configured to capture audio data. Some possible examples of audio sensors 460 may include: connectors to microphones; microphones; unidirectional microphones; bidirectional microphones; cardioid microphones; omnidirectional microphones; onboard microphones; wired microphones; wireless microphones; any combination of the above; and so forth. In some cases, audio data captured using audio sensors 460 may be stored in memory, for example in memory units 420. In some cases, audio data captured using audio sensors 460 may be transmitted, for example using communication device 440 to an external system, such as server 500, cloud platform 600, computational node 610, apparatus 400, and so forth. In some cases, audio data captured using audio sensors 460 may be processed, for example using processing units 430. For example, the audio data captured using audio sensors 460 may be: compressed; preprocessed using filters, such as low pass filters, high pass filters, etc.; downsampled; and so forth. In some cases, audio data captured using audio sensors 460 may be analyzed, for example using processing units 430. For example, audio data captured using audio sensors 460 may be analyzed to identify low level features, speakers, speech, audio triggers, and so forth. In another example, audio data captured using audio sensors 460 may be applied to an inference model.

In some embodiments, the one or more image sensors 471 may be configured to capture visual data. Some possible examples of image sensors 471 may include: CCD sensors; CMOS sensors; stills image sensors; video image sensors; 2D image sensors; 3D image sensors; and so forth. Some possible examples of visual data may include: still images; video clips; continuous video; 2D images; 2D videos; 3D images; 3D videos; microwave images; terahertz images; ultraviolet images; infrared images; x-ray images; gamma ray images; visible light images; microwave videos; terahertz videos; ultraviolet videos; infrared videos; visible light videos; x-ray videos; gamma ray videos; and so forth. In some cases, visual data captured using image sensors 471 may be stored in memory, for example in memory units 420. In some cases, visual data captured using image sensors 471 may be transmitted, for example using communication device 440 to an external system, such as server 500, cloud platform 600, computational node 610, apparatus 400, and so forth. In some cases, visual data captured using image sensors 471 may be processed, for example using processing units 430. For example, the visual data captured using image sensors 471 may be: compressed; preprocessed using filters, such as low pass filter, high pass filter, etc.; downsampled; and so forth. In some cases, visual data captured using image sensors 471 may be analyzed, for example using processing units 430. For example, visual data captured using image sensors 471 may be analyzed to identify one or more of: low level visual features; objects; faces; persons; events; visual triggers; and so forth. In another example, visual data captured using image sensors 471 may be applied to an inference model.

In some embodiments, the one or more physiological sensors 472 may be configured to capture physiological data. Some possible examples of physiological sensors 472 may include: glucose sensors; electrocardiogram sensors; electroencephalogram sensors; electromyography sensors; odor sensors; respiration sensors; blood pressure sensors; pulse oximeter sensors; heart rate sensors; perspiration sensors; and so forth. In some cases, physiological data captured using physiological sensors 472 may be stored in memory, for example in memory units 420. In some cases, physiological data captured using physiological sensors 472 may be transmitted, for example using communication device 440 to an external system, such as server 500, cloud platform 600, computational node 610, apparatus 400, and so forth. In some cases, physiological data captured using physiological sensors 472 may be processed, for example using processing units 430. For example, the physiological data captured using physiological sensors 472 may be compressed, downsampled, and so forth. In some cases, physiological data captured using physiological sensors 472 may be analyzed, for example using processing units 430. For example, physiological data captured using physiological sensors 472 may be analyzed to identify events, triggers, and so forth. In another example, physiological data captured using physiological sensors 472 may be applied to an inference model.

In some embodiments, the one or more accelerometers 473 may be configured to capture proper acceleration information, for example by: measuring proper acceleration of apparatus 400; detecting changes in proper acceleration of apparatus 400; and so forth. In some embodiments, the one or more accelerometers 473 may comprise one or more gyroscopes. In some cases, information captured using accelerometers 473 may be stored in memory, for example in memory units 420. In some cases, information captured using accelerometers 473 may be transmitted, for example using communication device 440 to an external system, such as server 500, cloud platform 600, computational node 610, apparatus 400, and so forth. In some cases, information captured using accelerometers 473 may be processed, for example using processing units 430. For example, the information captured using accelerometers 473 may be compressed, downsampled, and so forth. In some cases, information captured using accelerometers 473 may be analyzed, for example using processing units 430. For example, the information captured using accelerometers 473 may be analyzed to identify events, triggers, and so forth. In another example, the information captured using accelerometers 473 may be applied to an inference model.

In some embodiments, the one or more positioning sensors 474 may be configured to: obtain positioning information associated with apparatus 400; detect changes in the position of apparatus 400; and so forth. In some embodiments, the positioning sensors 474 may be implemented using different technologies, such as: Global Positioning System (GPS); GLObal NAvigation Satellite System (GLONASS); Galileo global navigation system, BeiDou navigation system; other Global Navigation Satellite Systems (GNSS); Indian Regional Navigation Satellite System (IRNSS); Local Positioning Systems (LPS), Real-Time Location Systems (RTLS); Indoor Positioning System (IPS); Wi-Fi based positioning systems; cellular triangulation; and so forth. In some embodiments, the one or more positioning sensors 474 may comprise one or more altimeters, and be configured to measure altitude and/or to detect changes in altitude. In some embodiments, information captured using positioning sensors 474 may be stored in memory, for example in memory units 420. In some cases, information captured using positioning sensors 474 may be transmitted, for example using communication device 440 to an external system, such as server 500, cloud platform 600, computational node 610, apparatus 400, and so forth. In some cases, information captured using positioning sensors 474 may be processed, for example using processing units 430. For example, the information captured using positioning sensors 474 may be compressed, downsampled, and so forth. In some cases, information captured using positioning sensors 474 may be analyzed, for example using processing units 430. For example, the information captured using positioning sensors 474 may be analyzed to identify events, triggers, and so forth. In another example, the information captured using positioning sensors 474 may be applied to an inference model.

FIG. 5 is a block diagram illustrating a possible implementation of a server 500. In this example, server 500 comprises: one or more power sources 410; one or more memory units 420; one or more processing units 430; and one or more communication modules 440. In some implementations additional components may be included in server 500, while some components listed above may be excluded. In some embodiments, power sources 410 and/or communication modules 440 may be excluded from the implementation of server 500. In some embodiments, server 500 may further comprise one or more of the followings: one or more audio output units 451; one or more visual outputting units 452; one or more tactile outputting units 453; one or more audio sensors 460; one or more image sensors 471; one or more accelerometers 473; one or more positioning sensors 474; one or more chemical sensors; one or more temperature sensors; one or more barometers; one or more environmental sensors; one or more pressure sensors; one or more proximity sensors; one or more electrical impedance sensors; one or more electrical voltage sensors; one or more electrical current sensors; one or more clocks; one or more user input devices; one or more keyboards; one or more mouses; one or more touch pads; one or more touch screens; one or more antennas; one or more output devices; one or more audio speakers; one or more display screens; one or more augmented reality display systems; one or more LED indicators; and so forth.

FIG. 6A is a block diagram illustrating a possible implementation of cloud platform 600. In some examples, cloud platform 600 may comprise a number of computational nodes, in this example four computational nodes: computational node 610a, computational node 610b, computational node 610c and computational node 610d. In some examples, a possible implementation of computational nodes 610a, 610b, 610c and/or 610d may comprise server 500 as described in FIG. 5. In some examples, a possible implementation of computational nodes 610a, 610b, 610c and/or 610d may comprise computational node 610 as described in FIG. 7.

FIG. 6B is a block diagram illustrating a possible implementation of cloud platform 600. In this example, cloud platform 600 comprises: one or more computational nodes 610; one or more power sources 410; one or more shared memory modules 620; one or more external communication modules 640; one or more internal communication modules 650; one or more load balancing modules 660; and one or more node registration modules 670. In some implementations additional components may be included in cloud platform 600, while some components listed above may be excluded. In some embodiments, one or more of the followings may be excluded from the implementation of cloud platform 600: power sources 410; shared memory modules 620; external communication modules 640; internal communication modules 650; load balancing modules 660; and node registration modules 670. In some embodiments, cloud platform 600 may further comprise one or more of the followings: one or more audio output units 451; one or more visual outputting units 452; one or more tactile outputting units 453; one or more audio sensors 460; one or more image sensors 471; one or more accelerometers 473; one or more positioning sensors 474; one or more chemical sensors; one or more temperature sensors; one or more barometers; one or more environmental sensors; one or more pressure sensors; one or more proximity sensors; one or more electrical impedance sensors; one or more electrical voltage sensors; one or more electrical current sensors; one or more clocks; one or more user input devices; one or more keyboards; one or more mouses; one or more touch pads; one or more touch screens; one or more antennas; one or more output devices; one or more audio speakers; one or more display screens; one or more augmented reality display systems; one or more LED indicators; and so forth.

FIG. 7 is a block diagram illustrating a possible implementation of computational node 610 of a cloud platform, such as cloud platform 600. In this example computational node 610 comprises: one or more power sources 410; one or more memory units 420; one or more processing units 430; one or more shared memory access modules 710; one or more external communication modules 640; and one or more internal communication modules 650. In some implementations additional components may be included in computational node 610, while some components listed above may be excluded. In some embodiments, one or more of the followings may be excluded from the implementation of computational node 610: power sources 410; memory units 420; shared memory access modules 710; external communication modules 640; and internal communication modules 650. In some embodiments, computational node 610 may further comprise one or more of the followings: one or more audio output units 451; one or more visual outputting units 452; one or more tactile outputting units 453; one or more audio sensors 460; one or more image sensors 471; one or more accelerometers 473; one or more positioning sensors 474; one or more chemical sensors; one or more temperature sensors; one or more barometers; one or more environmental sensors; one or more pressure sensors; one or more proximity sensors; one or more electrical impedance sensors; one or more electrical voltage sensors; one or more electrical current sensors; one or more clocks; one or more user input devices; one or more keyboards; one or more mouses; one or more touch pads; one or more touch screens; one or more antennas; one or more output devices; one or more audio speakers; one or more display screens; one or more augmented reality display systems; one or more LED indicators; and so forth.

In some embodiments, external communication modules 640 and internal communication modules 650 may be implemented as a combined communication module, for example as communication modules 440. In some embodiments, one possible implementation of cloud platform 600 may comprise server 500. In some embodiments, one possible implementation of computational node 610 may comprise server 500. In some embodiments, one possible implementation of shared memory access modules 710 may comprise the usage of internal communication modules 650 to send information to shared memory modules 620 and/or receive information from shared memory modules 620. In some embodiments, node registration modules 670 and load balancing modules 660 may be implemented as a combined module.

In some embodiments, the one or more shared memory modules 620 may be accessed by more than one computational node. Therefore, shared memory modules 620 may allow information sharing among two or more computational nodes 610. In some embodiments, the one or more shared memory access modules 710 may be configured to enable access of computational nodes 610 and/or the one or more processing units 430 of computational nodes 610 to shared memory modules 620. In some examples, computational nodes 610 and/or the one or more processing units 430 of computational nodes 610, may access shared memory modules 620, for example using shared memory access modules 710, in order to perform one or more of: executing software programs stored on shared memory modules 620; store information in shared memory modules 620; retrieve information from the shared memory modules 620; and so forth.

In some embodiments, the one or more internal communication modules 650 may be configured to receive information from one or more components of cloud platform 600, and/or to transmit information to one or more components of cloud platform 600. For example, control signals and/or synchronization signals may be sent and/or received through internal communication modules 650. In another example, input information for computer programs, output information of computer programs, and/or intermediate information of computer programs, may be sent and/or received through internal communication modules 650. In another example, information received though internal communication modules 650 may be stored in memory units 420, in shared memory modules 620, and so forth. In an additional example, information retrieved from memory units 420 and/or shared memory modules 620 may be transmitted using internal communication modules 650. In another example, user input data may be transmitted and/or received using internal communication modules 650.

In some embodiments, the one or more external communication modules 640 may be configured to receive and/or to transmit information. For example, control signals and/or synchronization signals may be sent and/or received through external communication modules 640. In another example, information received though external communication modules 640 may be stored in memory units 420, in shared memory modules 620, and so forth. In an additional example, information retrieved from memory units 420 and/or shared memory modules 620 may be transmitted using external communication modules 640. In another example, input data may be transmitted and/or received using external communication modules 640.

Examples of such input data may include: input data inputted by a user using user input devices; information captured from the environment of apparatus 400 using one or more sensors; and so forth. Examples of such sensors may include: audio sensors 460; image sensors 471; physiological sensors 472; accelerometers 473; and positioning sensors 474; chemical sensors; temperature sensors; barometers; environmental sensors; pressure sensors; proximity sensors; electrical impedance sensors; electrical voltage sensors; electrical current sensors; and so forth.

In some embodiments, the one or more node registration modules 670 may be configured to track the availability of the computational nodes 610. In some examples, node registration modules 670 may be implemented as: a software program, such as a software program executed by one or more of the computational nodes 610; a hardware solution; a combined software and hardware solution; and so forth. In some implementations, node registration modules 670 may communicate with computational nodes 610, for example using internal communication modules 650. In some examples, computational nodes 610 may notify node registration modules 670 of their status, for example by sending messages: at computational node 610 startups; at computational node 610 shutdowns; at periodic times; at selected times; in response to queries received from node registration modules 670; and so forth. In some examples, node registration modules 670 may query about computational nodes 610 status, for example by sending messages: at node registration module 670 startups; at periodic times; at selected times; and so forth.

In some embodiments, the one or more load balancing modules 660 may be configured to divide the work load among computational nodes 610. In some examples, load balancing modules 660 may be implemented as: a software program, such as a software program executed by one or more of the computational nodes 610; a hardware solution; a combined software and hardware solution; and so forth. In some implementations, load balancing modules 660 may interact with node registration modules 670 in order to obtain information regarding the availability of the computational nodes 610. In some implementations, load balancing modules 660 may communicate with computational nodes 610, for example using internal communication modules 650. In some examples, computational nodes 610 may notify load balancing modules 660 of their status, for example by sending messages: at computational node 610 startups; at computational node 610 shutdowns; at periodic times; at selected times; in response to queries received from load balancing modules 660; and so forth. In some examples, load balancing modules 660 may query about computational nodes 610 status, for example by sending messages: at load balancing module 660 startups; at periodic times; at selected times; and so forth.

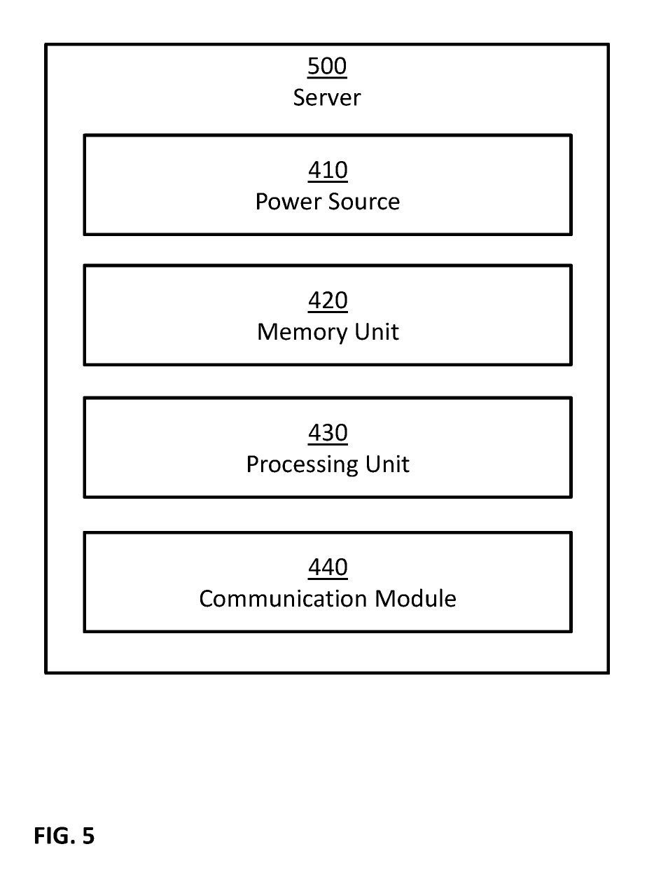

FIG. 8 illustrates an example of a process 800 for obtaining and/or analyzing audio data. In some examples, process 800, as well as all individual steps therein, may be performed by various aspects of: apparatus 400; server 500; cloud platform 600; computational node 610; and so forth. For example, process 800 may be performed by processing units 430, executing software instructions stored within memory units 420 and/or within shared memory modules 620. In this example, process 800 may comprise:

obtaining audio data (Step 810); and preprocessing audio data (Step 820). In some implementations, process 800 may comprise one or more additional steps, while some of the steps listed above may be modified or excluded. In some implementations, one or more steps illustrated in FIG. 8 may be executed in a different order and/or one or more groups of steps may be executed simultaneously and vice versa. For example, Step 820 may be executed after and/or simultaneously with Step 810. Examples of possible execution manners of process 800 may include: continuous execution, returning to the beginning of the process and/or to Step 820 once the process normal execution ends; periodically execution, executing the process at selected times; execution upon the detection of a trigger, where examples of such trigger may include a trigger from a user, a trigger from another process, etc.; any combination of the above; and so forth.

In some embodiments, obtaining audio data (Step 810) may comprise obtaining audio data, such as audio data captured using: one or more audio sensors, such as audio sensors 460; one or more wearable audio sensors, such as a wearable version of audio sensors 460; any combination of the above; and so forth. In some embodiments, a user may wear a wearable apparatus comprising one or more audio sensors, such as a wearable version of apparatus 400, and obtaining audio data (Step 810) may comprise obtaining audio data captured from the environment of the user using the one or more audio sensors, such as audio sensors 460. In some embodiments, obtaining audio data (Step 810) may comprise receiving audio data from an external device, for example through a communication device such as communication modules 440, external communication modules 640, internal communication modules 650, and so forth. In some embodiments, obtaining audio data (Step 810) may comprise reading audio data from a memory unit, such as memory units 420, shared memory modules 620, and so forth. In some embodiments, obtaining audio data (Step 810) may comprise capturing the audio data. In some examples, capturing the audio data may comprise capturing the audio data using one or more audio sensors, such as audio sensors 460; one or more wearable audio sensors, such as a wearable version of audio sensors 460; any combination of the above; and so forth. In some examples, capturing the audio data may comprise capturing the audio data from the environment of a user using one or more wearable audio sensors, such as a wearable version of audio sensors 460. In some embodiments, obtaining audio data (Step 810) may comprise obtaining audio data captured: continuously; at selected times; when specific conditions are met; upon a detection of a trigger; and so forth.

In some embodiments, preprocessing audio data (Step 820) may comprise analyzing the audio data to obtain a preprocessed audio data, for example by a processing unit, such as processing units 430. One of ordinary skill in the art will recognize that the followings are examples, and that the audio data may be preprocessed using other kinds of preprocessing methods. In some examples, the audio data may be preprocessed by transforming the audio data using a transformation function to obtain a transformed audio data, and the preprocessed audio data may comprise the transformed audio data. For example, the transformation function may comprise a multiplication of a vectored time series representation of the audio data with a transformation matrix. For example, the transformed audio data may comprise one or more convolutions of the audio data. For example, the transformation function may comprise one or more audio filters, such as low-pass filters, high-pass filters, band-pass filters, all-pass filters, and so forth. In some examples, the transformation function may comprise a nonlinear function. In some examples, the audio data may be preprocessed by smoothing the audio data, for example using Gaussian convolution, using a median filter, and so forth. In some examples, the audio data may be preprocessed to obtain a different representation of the audio data. For example, the preprocessed audio data may comprise: a representation of at least part of the audio data in a frequency domain; a Discrete Fourier Transform of at least part of the audio data; a Discrete Wavelet Transform of at least part of the audio data; a time/frequency representation of at least part of the audio data; a spectrogram of at least part of the audio data; a log spectrogram of at least part of the audio data; a Mel-Frequency Cepstrum of at least part of the audio data; a sonogram of at least part of the audio data; a periodogram of at least part of the audio data; a representation of at least part of the audio data in a lower dimension; a lossy representation of at least part of the audio data; a lossless representation of at least part of the audio data; a time order series of any of the above; any combination of the above; and so forth. In some examples, the audio data may be preprocessed to extract audio features from the audio data. Some examples of such audio features may include: auto-correlation; number of zero crossings of the audio signal; number of zero crossings of the audio signal centroid; MP3 based features; rhythm patterns; rhythm histograms; spectral features, such as spectral centroid, spectral spread, spectral skewness, spectral kurtosis, spectral slope, spectral decrease, spectral roll-off, spectral variation, etc.; harmonic features, such as fundamental frequency, noisiness, inharmonicity, harmonic spectral deviation, harmonic spectral variation, tristimulus, etc.; statistical spectrum descriptors; wavelet features; higher level features; perceptual features, such as total loudness, specific loudness, relative specific loudness, sharpness, spread, etc.; energy features, such as total energy, harmonic part energy, noise part energy, etc.; temporal features; and so forth.

In some embodiments, analysis of the audio data may be performed on the raw audio data, on the preprocessed audio data, on a combination of the raw audio data and the preprocessed audio data, and so forth. Some examples of audio data preprocessing and/or preprocessed audio data are described above. In some examples, the analysis of the audio data and/or the preprocessed audio data may be based, at least in part, on one or more rules. The one or more rules may be applied to the raw audio data, to the preprocessed audio data, to a combination of the raw audio data and the preprocessed audio data, and so forth. In some examples, the analysis of an audio data and/or the preprocessed audio data may comprise one or more functions and/or procedures applied to the raw audio data, to the preprocessed audio data, to a combination of the raw audio data and the preprocessed audio data, and so forth. In some examples, an analysis of the audio data and/or the preprocessed audio data may comprise applying to one or more inference models: the raw audio data, the preprocessed audio data, a combination of the raw audio data and the preprocessed audio data, and so forth. Some examples of such inference models may comprise: a classification model; a regression model; an inference model preprogrammed manually; a result of training algorithms, such as machine learning algorithms and/or deep learning algorithms, on training examples, where the training examples may include examples of data instances, and in some cases, each data instance may be labeled with a corresponding desired label and/or result; and so forth. In some examples, the analysis of the audio data may comprise one or more neural networks, where the input to the neural networks may comprise: the raw audio data, the preprocessed audio data, a combination of the raw audio data and the preprocessed audio data, and so forth.

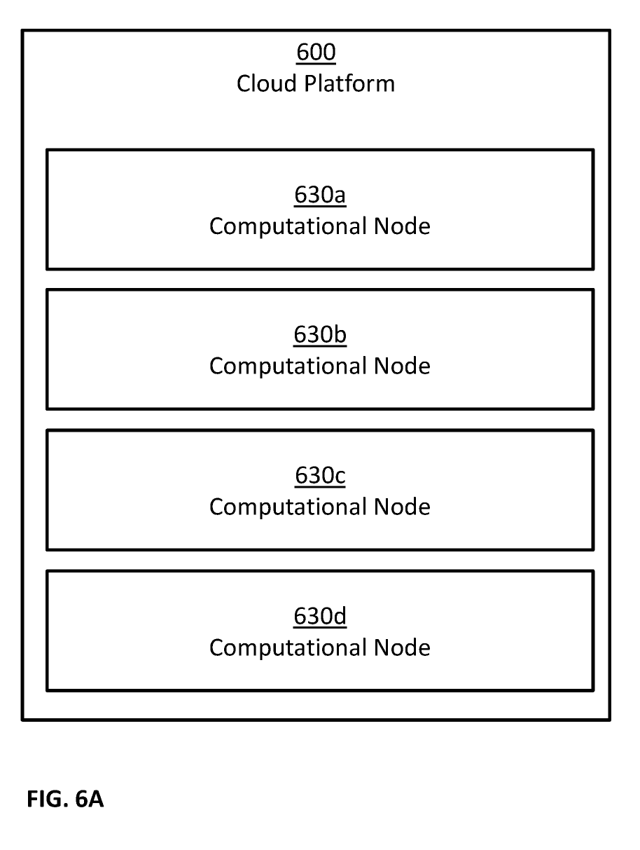

FIG. 9 illustrates an example of a process 900 for obtaining and/or analyzing motion data. In some examples, process 900, as well as all individual steps therein, may be performed by various aspects of: apparatus 400; server 500; cloud platform 600; computational node 610; and so forth. For example, process 900 may be performed by processing units 430, executing software instructions stored within memory units 420 and/or within shared memory modules 620. In this example, process 900 may comprise: obtaining motion data (Step 910); and preprocessing motion data (Step 920). In some implementations, process 900 may comprise one or more additional steps, while some of the steps listed above may be modified or excluded. In some implementations, one or more steps illustrated in FIG. 9 may be executed in a different order and/or one or more groups of steps may be executed simultaneously and vice versa. For example, Step 920 may be executed after and/or simultaneously with Step 910. Examples of possible execution manners of process 900 may include: continuous execution, returning to the beginning of the process and/or to Step 920 once the process normal execution ends; periodically execution, executing the process at selected times; execution upon the detection of a trigger, where examples of such trigger may include a trigger from a user, a trigger from another process, etc.; any combination of the above; and so forth.

In some embodiments, obtaining motion data (Step 910) may comprise obtaining and/or capturing motion data from one or more sensors, for example using accelerometers 473 and/or gyroscopes and/or positioning sensors 474 included in apparatus 400. In some examples, the one or more sensors may comprise one or more wearable sensors, such as accelerometers 473 and/or gyroscopes and/or positioning sensors 474 included in a wearable version of apparatus 400. In some embodiments, motion data obtained by Step 910 may be synchronized with audio data obtained by Step 810 and/or with physiological data obtained by Step 1010 and/or with positioning data obtained by Step 1110. In some embodiments, obtaining motion data (Step 910) may comprise receiving motion data from an external device, for example through a communication device such as communication modules 440, external communication modules 640, internal communication modules 650, and so forth. In some embodiments, obtaining motion data (Step 910) may comprise reading motion data from a memory unit, such as memory units 420, shared memory modules 620, and so forth. In some embodiments, obtaining motion data (Step 910) may comprise obtaining motion data captured: continuously; at selected times; when specific conditions are met; upon a detection of a trigger; and so forth.

In some embodiments, preprocessing motion data (Step 920) may comprise analyzing motion data, such as the motion data obtain by Step 910, to obtain a preprocessed motion data, for example by a processing unit, such as processing units 430. One of ordinary skill in the art will recognize that the followings are examples, and that the motion data may be preprocessed using other kinds of preprocessing methods. In some examples, the motion data may be preprocessed by transforming the motion data using a transformation function to obtain a transformed motion data, and the preprocessed motion data may comprise the transformed motion data. For example, the transformed motion data may comprise one or more convolutions of the motion data. For example, the transformation function may comprise one or more filters, such as low-pass filters, high-pass filters, band-pass filters, all-pass filters, and so forth. In some examples, the transformation function may comprise a nonlinear function. In some examples, the motion data may be preprocessed by smoothing the motion data, for example using Gaussian convolution, using a median filter, and so forth. In some examples, the motion data may be preprocessed to obtain a different representation of the motion data. For example, the preprocessed motion data may comprise: a representation of at least part of the motion data in a frequency domain; a Discrete Fourier Transform of at least part of the motion data; a Discrete Wavelet Transform of at least part of the motion data; a time/frequency representation of at least part of the motion data; a representation of at least part of the motion data in a lower dimension; a lossy representation of at least part of the motion data; a lossless representation of at least part of the motion data; a time order series of any of the above; any combination of the above; and so forth. In some examples, the motion data may be preprocessed to detect features and/or motion patterns within the motion data, and the preprocessed motion data may comprise information based on and/or related to the detected features and/or the detected motion patterns.

In some embodiments, analysis of the motion data may be performed on the raw motion data, on the preprocessed motion data, on a combination of the raw motion data and the preprocessed motion data, and so forth. Some examples of motion data preprocessing and/or preprocessed motion data are described above. In some examples, the analysis of the motion data and/or the preprocessed motion data may be based, at least in part, on one or more rules. The one or more rules may be applied to the raw motion data, to the preprocessed motion data, to a combination of the raw motion data and the preprocessed motion data, and so forth. In some examples, the analysis of the motion data and/or the preprocessed motion data may comprise one or more functions and/or procedures applied to the raw motion data, to the preprocessed motion data, to a combination of the raw motion data and the preprocessed motion data, and so forth. In some examples, the analysis of the motion data and/or the preprocessed motion data may comprise applying to one or more inference models: the raw motion data, the preprocessed motion data, a combination of the raw motion data and the preprocessed motion data, and so forth. Some examples of such inference models may comprise: an inference model preprogrammed manually; a classification model; a regression model; a result of training algorithms, such as machine learning algorithms and/or deep learning algorithms, on training examples, where the training examples may include examples of data instances, and in some cases, each data instance may be labeled with a corresponding desired label and/or result; and so forth. In some examples, the analysis of the motion data and/or the preprocessed motion data may comprise one or more neural networks, where the input to the neural networks may comprise: the raw motion data, the preprocessed motion data, a combination of the raw motion data and the preprocessed motion data, and so forth.

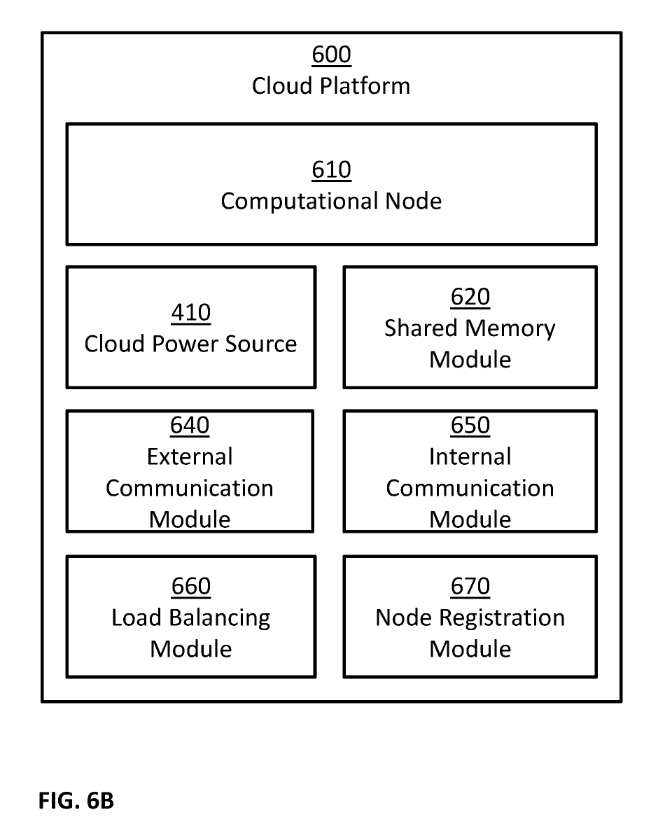

FIG. 10 illustrates an example of a process 1000 for obtaining and/or analyzing physiological data. In some examples, process 1000, as well as all individual steps therein, may be performed by various aspects of: apparatus 400; server 500; cloud platform 600; computational node 610; and so forth. For example, process 1000 may be performed by processing units 430, executing software instructions stored within memory units 420 and/or within shared memory modules 620. In this example, process 1000 may comprise: obtaining physiological data (Step 1010); and preprocessing physiological data (Step 1020). In some implementations, process 1000 may comprise one or more additional steps, while some of the steps listed above may be modified or excluded. In some implementations, one or more steps illustrated in FIG. 10 may be executed in a different order and/or one or more groups of steps may be executed simultaneously and vice versa. For example, Step 1020 may be executed after and/or simultaneously with Step 1010. Examples of possible execution manners of process 1000 may include: continuous execution, returning to the beginning of the process and/or to Step 1020 once the process normal execution ends; periodically execution, executing the process at selected times; execution upon the detection of a trigger, where examples of such trigger may include a trigger from a user, a trigger from another process, etc.; any combination of the above; and so forth.

In some embodiments, obtaining physiological data (Step 1010) may comprise obtaining and/or capturing physiological data from one or more physiological sensors, for example using physiological sensors 472 included in apparatus 400. In some examples, one or more physiological sensors may comprise one or more wearable physiological sensors, such as physiological sensors 472 included in a wearable version of apparatus 400. Some examples of such physiological sensors are listed above. In some embodiments, physiological data obtained by Step 1010 may be synchronized with audio data obtained by Step 810 and/or with motion data obtained by Step 910 and/or with positioning data obtained by Step 1110. In some embodiments, obtaining physiological data (Step 1010) may comprise receiving physiological data from an external device, for example through a communication device such as communication modules 440, external communication modules 640, internal communication modules 650, and so forth. In some embodiments, obtaining physiological data (Step 1010) may comprise reading physiological data from a memory unit, such as memory units 420, shared memory modules 620, and so forth. In some embodiments, obtaining physiological data (Step 1010) may comprise obtaining physiological data captured: continuously; at selected times; when specific conditions are met; upon a detection of a trigger; and so forth.

In some embodiments, preprocessing physiological data (Step 1020) may comprise analyzing physiological data, such as the physiological data obtain by Step 1010, to obtain a preprocessed physiological data, for example by a processing unit, such as processing units 430. One of ordinary skill in the art will recognize that the followings are examples, and that the physiological data may be preprocessed using other kinds of preprocessing methods. In some examples, the physiological data may be preprocessed by transforming the physiological data using a transformation function to obtain a transformed physiological data, and the preprocessed physiological data may comprise the transformed physiological data. For example, the transformed physiological data may comprise one or more convolutions of the physiological data. For example, the transformation function may comprise one or more filters, such as low-pass filters, high-pass filters, band-pass filters, all-pass filters, and so forth. In some examples, the transformation function may comprise a nonlinear function. In some examples, the physiological data may be preprocessed by smoothing the physiological data, for example using Gaussian convolution, using a median filter, and so forth. In some examples, the physiological data may be preprocessed to obtain a different representation of the physiological data. For example, the preprocessed physiological data may comprise: a representation of at least part of the physiological data in a frequency domain; a Discrete Fourier Transform of at least part of the physiological data; a Discrete Wavelet Transform of at least part of the physiological data; a time/frequency representation of at least part of the physiological data; a representation of at least part of the physiological data in a lower dimension; a lossy representation of at least part of the physiological data; a lossless representation of at least part of the physiological data; a time order series of any of the above; any combination of the above; and so forth. In some examples, the physiological data may be preprocessed to detect features within the physiological data, and the preprocessed physiological data may comprise information based on and/or related to the detected features.

In some embodiments, analysis of the physiological data may be performed on the raw physiological data, on the preprocessed physiological data, on a combination of the raw physiological data and the preprocessed physiological data, and so forth. Some examples of physiological data preprocessing and/or preprocessed physiological data are described above. In some examples, the analysis of the physiological data and/or the preprocessed physiological data may be based, at least in part, on one or more rules. The one or more rules may be applied to the raw physiological data, to the preprocessed physiological data, to a combination of the raw physiological data and the preprocessed physiological data, and so forth. In some examples, the analysis of the physiological data and/or the preprocessed physiological data may comprise one or more functions and/or procedures applied to the raw physiological data, to the preprocessed physiological data, to a combination of the raw physiological data and the preprocessed physiological data, and so forth. In some examples, the analysis of the physiological data and/or the preprocessed physiological data may comprise applying to one or more inference models: the raw physiological data, the preprocessed physiological data, a combination of the raw physiological data and the preprocessed physiological data, and so forth. Some examples of such inference models may comprise: an inference model preprogrammed manually; a classification model; a regression model; a result of training algorithms, such as machine learning algorithms and/or deep learning algorithms, on training examples, where the training examples may include examples of data instances, and in some cases, each data instance may be labeled with a corresponding desired label and/or result; and so forth. In some examples, the analysis of the physiological data and/or the preprocessed physiological data may comprise one or more neural networks, where the input to the neural networks may comprise: the raw physiological data, the preprocessed physiological data, a combination of the raw physiological data and the preprocessed physiological data, and so forth.

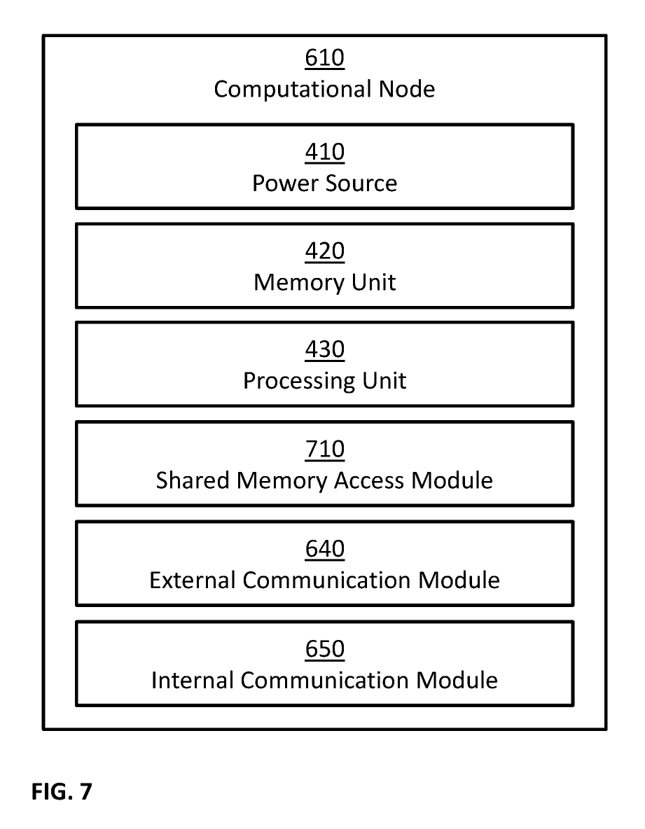

FIG. 11 illustrates an example of a process 1100 for obtaining and/or analyzing positioning data. In some examples, process 1100, as well as all individual steps therein, may be performed by various aspects of: apparatus 400; server 500; cloud platform 600; computational node 610; and so forth. For example, process 1100 may be performed by processing units 430, executing software instructions stored within memory units 420 and/or within shared memory modules 620. In this example, process 1100 may comprise: obtaining positioning data (Step 1110); and preprocessing positioning data (Step 1120). In some implementations, process 1100 may comprise one or more additional steps, while some of the steps listed above may be modified or excluded. In some implementations, one or more steps illustrated in FIG. 11 may be executed in a different order and/or one or more groups of steps may be executed simultaneously and vice versa. For example, Step 1120 may be executed after and/or simultaneously with Step 1110. Examples of possible execution manners of process 1100 may include: continuous execution, returning to the beginning of the process and/or to Step 1120 once the process normal execution ends; periodically execution, executing the process at selected times; execution upon the detection of a trigger, where examples of such trigger may include a trigger from a user, a trigger from another process, etc.; any combination of the above; and so forth.

In some embodiments, obtaining positioning data (Step 1110) may comprise obtaining and/or capturing positioning data from one or more sensors, for example using positioning sensors 474 included in apparatus 400. In some examples, the one or more sensors may comprise one or more wearable sensors, such as positioning sensors 474 included in a wearable version of apparatus 400. In some embodiments, positioning data obtained by Step 1110 may be synchronized with audio data obtained by Step 810 and/or with motion data obtained by Step 910 and/or with physiological data obtained by Step 1010. In some embodiments, obtaining positioning data (Step 1110) may comprise receiving positioning data from an external device, for example through a communication device such as communication modules 440, external communication modules 640, internal communication modules 650, and so forth. In some embodiments, obtaining positioning data (Step 1110) may comprise reading positioning data from a memory unit, such as memory units 420, shared memory modules 620, and so forth. In some embodiments, obtaining positioning data (Step 1110) may comprise obtaining positioning data captured: continuously; at selected times; when specific conditions are met; upon a detection of a trigger; and so forth.

In some embodiments, preprocessing positioning data (Step 1120) may comprise analyzing positioning data, such as the positioning data obtain by Step 1110, to obtain a preprocessed positioning data, for example by a processing unit, such as processing units 430. One of ordinary skill in the art will recognize that the followings are examples, and that the positioning data may be preprocessed using other kinds of preprocessing methods. In some examples, the positioning data may be preprocessed by transforming the positioning data using a transformation function to obtain a transformed positioning data, and the preprocessed positioning data may comprise the transformed positioning data. For example, the transformed positioning data may comprise one or more convolutions of the positioning data. For example, the transformation function may comprise one or more filters, such as low-pass filters, high-pass filters, band-pass filters, all-pass filters, and so forth. In some examples, the transformation function may comprise a nonlinear function. In some examples, the positioning data may be preprocessed by smoothing the positioning data, for example using Gaussian convolution, using a median filter, and so forth. In some examples, the positioning data may be preprocessed to obtain a different representation of the positioning data. For example, the preprocessed positioning data may comprise: a representation of at least part of the positioning data in a frequency domain; a Discrete Fourier Transform of at least part of the positioning data; a Discrete Wavelet Transform of at least part of the positioning data; a time/frequency representation of at least part of the positioning data; a representation of at least part of the positioning data in a lower dimension; a lossy representation of at least part of the positioning data; a lossless representation of at least part of the positioning data; a time order series of any of the above; any combination of the above; and so forth. In some examples, the positioning data may be preprocessed to detect features and/or patterns within the positioning data, and the preprocessed positioning data may comprise information based on and/or related to the detected features and/or the detected patterns. In some examples, the positioning data may be preprocessed by comparing the positioning data to positions of known sites to determine sites from the positioning data.

In some embodiments, analysis of the positioning data may be performed on the raw positioning data, on the preprocessed positioning data, on a combination of the raw positioning data and the preprocessed positioning data, and so forth. Some examples of positioning data preprocessing and/or preprocessed positioning data are described above. In some examples, the analysis of the positioning data and/or the preprocessed positioning data may be based, at least in part, on one or more rules. The one or more rules may be applied to the raw positioning data, to the preprocessed positioning data, to a combination of the raw positioning data and the preprocessed positioning data, and so forth. In some examples, the analysis of the positioning data and/or the preprocessed positioning data may comprise one or more functions and/or procedures applied to the raw positioning data, to the preprocessed positioning data, to a combination of the raw positioning data and the preprocessed positioning data, and so forth. In some examples, the analysis of the positioning data and/or the preprocessed positioning data may comprise applying to one or more inference models: the raw positioning data, the preprocessed positioning data, a combination of the raw positioning data and the preprocessed positioning data, and so forth. Some examples of such inference models may comprise: an inference model preprogrammed manually; a classification model; a regression model; a result of training algorithms, such as machine learning algorithms and/or deep learning algorithms, on training examples, where the training examples may include examples of data instances, and in some cases, each data instance may be labeled with a corresponding desired label and/or result; and so forth. In some examples, the analysis of the positioning data and/or the preprocessed positioning data may comprise one or more neural networks, where the input to the neural networks may comprise: the raw positioning data, the preprocessed positioning data, a combination of the raw positioning data and the preprocessed positioning data, and so forth.

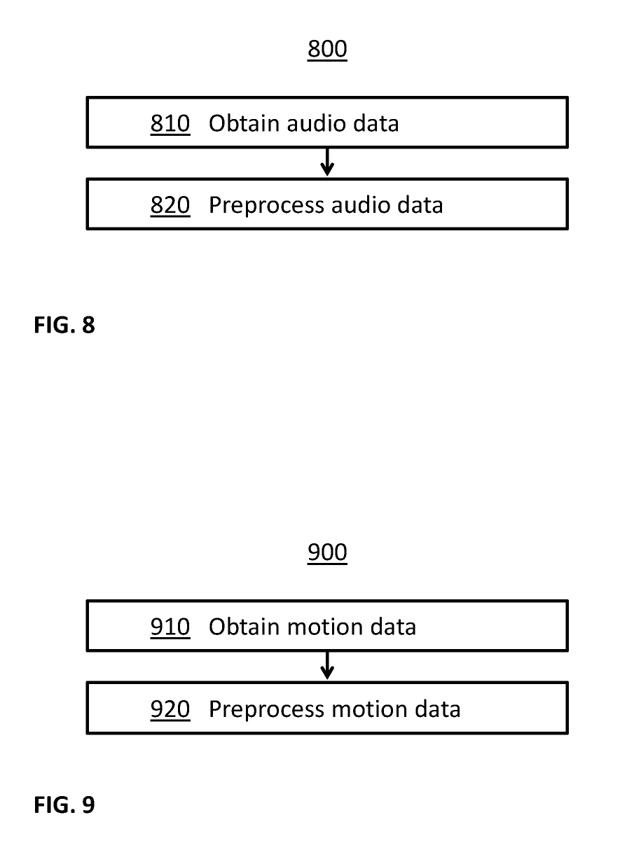

FIG. 12 illustrates an example of a process 1200 for analyzing audio data to obtain textual information. In some examples, process 1200, as well as all individual steps therein, may be performed by various aspects of: apparatus 400; server 500; cloud platform 600; computational node 610; and so forth. For example, process 1200 may be performed by processing units 430, executing software instructions stored within memory units 420 and/or within shared memory modules 620. In this example, process 1200 may comprise: obtaining audio data (Step 1210); and analyzing audio data to obtain textual information (Step 1220). In some implementations, process 1200 may comprise one or more additional steps, while some of the steps listed above may be modified or excluded. In some implementations, one or more steps illustrated in FIG. 12 may be executed in a different order and/or one or more groups of steps may be executed simultaneously and vice versa. For example, Step 1220 may be executed after and/or simultaneously with Step 1210. Examples of possible execution manners of process 1200 may include: continuous execution, returning to the beginning of the process and/or to Step 1220 once the process normal execution ends; periodically execution, executing the process at selected times; execution upon the detection of a trigger, where examples of such trigger may include a trigger from a user, a trigger from another process, etc.; any combination of the above; and so forth.

In some embodiments, obtaining audio data (Step 1210) may comprise obtaining audio data and/or preprocessed audio data, for example using process 800, using Step 810 and/or Step 820, and so forth.

In some embodiments, analyzing audio data to obtain textual information (Step 1220) may comprise analyzing the audio data and/or the preprocessed audio data to obtain information, including textual information, for example by a processing unit, such as processing units 430. In some examples, analyzing audio data to obtain textual information (Step 1220) may comprise using speech to text algorithms to transcribe spoken language in the audio data. In some examples, analyzing audio data to obtain textual information (Step 1220) may comprise: analyzing the audio data and/or the preprocessed audio data to identify words, keywords, and/or phrases in the audio data, for example using sound recognition algorithms; and representing the identified words, keywords, and/or phrases, for example in a textual manner, using graphical symbols, in a vector representation, as a pointer to a database of words, keywords, and/or phrases, and so forth. In some examples, analyzing audio data to obtain textual information (Step 1220) may comprise: analyzing the audio data and/or the preprocessed audio data using sound recognition algorithms to identify nonverbal sounds in the audio data; and describing the identified nonverbal sounds, for example in a textual manner, using graphical symbols, as a pointer to a database of sounds, and so forth. In some examples, analyzing audio data to obtain textual information (Step 1220) may comprise using acoustic fingerprint based algorithms to identify items in the audio data. Some examples of such items may include: songs, melodies, tunes, sound effects, and so forth. The identified items may be represented: in a textual manner; using graphical symbols; as a pointer to a database of items; and so forth. In some examples, analyzing audio data to obtain textual information (Step 1220) may comprise analyzing the audio data and/or the preprocessed audio data to obtain properties of voices present in the audio data, including properties associated with: pitch, intensity, tempo, rhythm, prosody, flatness, and so forth. In some examples, analyzing audio data to obtain textual information (Step 1220) may comprise: recognizing different voices, for example in different portions of the audio data; and/or identifying different properties of voices present in different parts of the audio data. As a result, different portions of the textual information may be associated with different voices and/or different properties. In some examples, different portions of the textual information may be associated with different textual formats, such as layouts, fonts, font sizes, font styles, font formats, font typefaces, and so forth. For example, different portions of the textual information may be associated with different textual formats based on different voices and/or different properties associated with the different portions of the textual information. Some examples of such speech to text algorithms and/or using sound recognition algorithms may include: hidden Markov models based algorithms; dynamic time warping based algorithms; neural networks based algorithms; machine learning and/or deep learning based algorithms; and so forth.

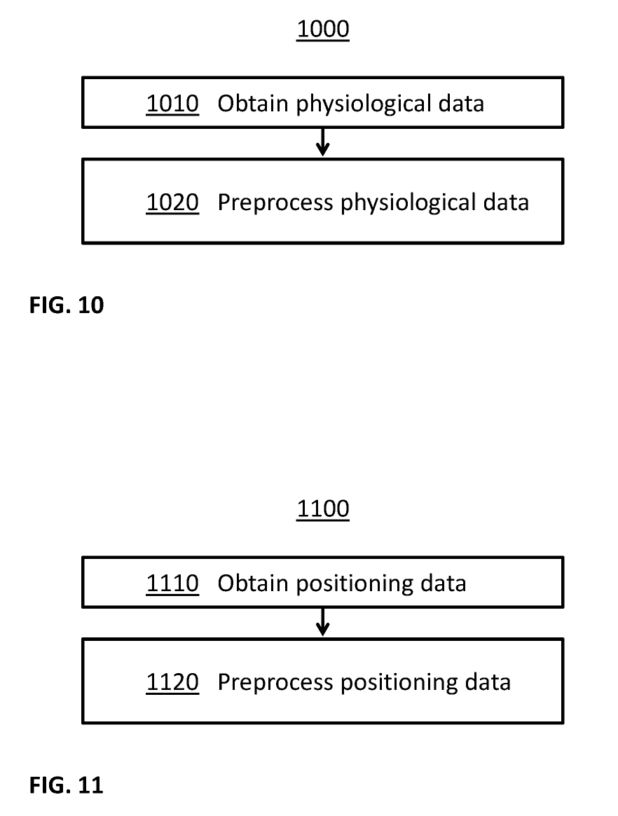

FIG. 13 illustrates an example of a process 1300 for identifying conversations. In some examples, process 1300, as well as all individual steps therein, may be performed by various aspects of: apparatus 400; server 500; cloud platform 600; computational node 610; and so forth. For example, process 1300 may be performed by processing units 430, executing software instructions stored within memory units 420 and/or within shared memory modules 620. In this example, process 1300 may comprise: obtaining audio data (Step 1210); and identifying conversations (Step 1320). In some implementations, process 1300 may comprise one or more additional steps, while some of the steps listed above may be modified or excluded. For example, Step 1210 may be excluded from process 1300. In some implementations, one or more steps illustrated in FIG. 13 may be executed in a different order and/or one or more groups of steps may be executed simultaneously and vice versa. For example, Step 1320 may be executed after and/or simultaneously with Step 1210. Examples of possible execution manners of process 1300 may include: continuous execution, returning to the beginning of the process and/or to Step 1320 once the process normal execution ends; periodically execution, executing the process at selected times; execution upon the detection of a trigger, where examples of such trigger may include a trigger from a user, a trigger from another process, etc.; any combination of the above; and so forth.

In some embodiments, identifying conversations (Step 1320) may comprise obtaining an indication that two or more speakers are engaged in conversation, for example by a processing unit, such as processing units 430. For example, speaker diarization information may be obtained, for example by using a speaker diarization algorithm. The speaker diarization information may be analyzed in order to identify which speakers are engaged in conversation at what time, for example by detecting a sequence in time in which two or more speakers talk in turns. In another example, clustering algorithms may be used to analyze the speaker diarization information and divide the speaker diarization information to conversations. In another example, the speaker diarization information may be divided when no activity is recorder in the speaker diarization information for duration longer than a selected threshold.

In some embodiments, identifying conversations (Step 1320) may comprise analyzing the audio data and/or the preprocessed audio data to identify a conversation in the audio data. Some examples of such analysis methods may include: the application of speaker diarization algorithms in order to obtain speaker diarization information, and analyzing the speaker diarization information as described above; the usage of neural networks trained to detect conversations within audio data, where the input to the neural networks may comprise the audio data and/or the preprocessed audio data; analyzing the audio data and/or the preprocessed audio data to obtain textual information, for example using process 1200 and/or Step 1220, and analyzing of the textual information to identify conversations, for example using textual conversation identification algorithms; and so forth. In some examples, speakers taking part in that conversation may be identified, for example using speaker recognition algorithms. Some examples of such speaker recognition algorithms may include: pattern recognition algorithms; hidden Markov models based algorithms; mixture of Gaussians based algorithms; pattern matching based algorithms; neural networks based algorithms; quantization based algorithms; machine learning and/or deep learning based algorithms; and so forth.

In some embodiments, identifying conversations (Step 1320) may comprise analyzing the visual data, such as visual data captured using image sensor 471, to identify a conversation involving two or more speakers visible in the visual data, and possibly in order to identify the speakers taking part in the conversation, for example using face recognition algorithms. Some examples of such analysis may comprise: usage of action recognition algorithms; usage of lips reading algorithms; and so forth. In some embodiments, identifying conversations (Step 1320) may comprise analyzing information coming from variety of sensors, for example identifying conversations based on an analysis of audio data and visual data, such as visual data captured using image sensor 471.

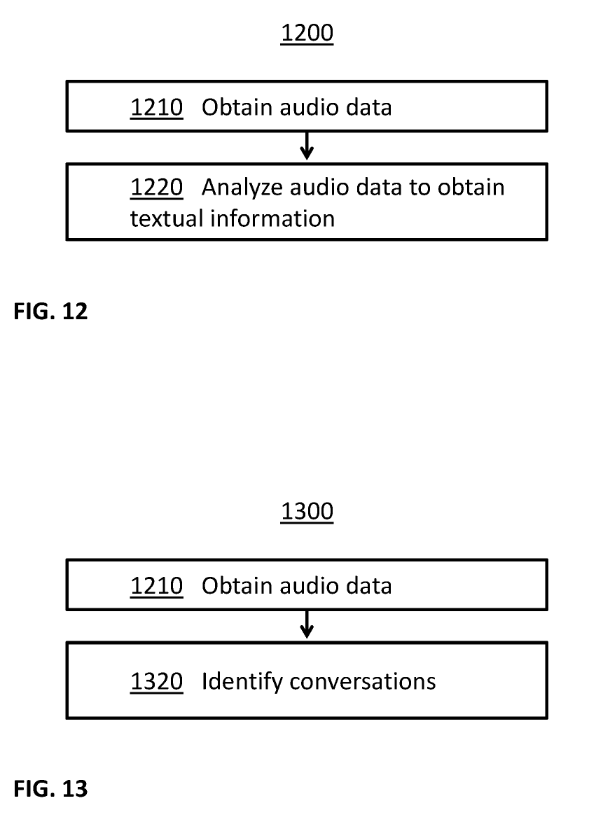

FIG. 14 illustrates an example of a process 1400 for identifying speakers. In some examples, process 1400, as well as all individual steps therein, may be performed by various aspects of: apparatus 400; server 500; cloud platform 600; computational node 610; and so forth. For example, process 1400 may be performed by processing units 430, executing software instructions stored within memory units 420 and/or within shared memory modules 620. In this example, process 1400 may comprise: obtaining audio data (Step 1210); and identifying speakers (Step 1420). In some implementations, process 1400 may comprise one or more additional steps, while some of the steps listed above may be modified or excluded. For example, Step 1210 may be excluded from process 1400. In some implementations, one or more steps illustrated in FIG. 14 may be executed in a different order and/or one or more groups of steps may be executed simultaneously and vice versa. For example, Step 1420 may be executed after and/or simultaneously with Step 1210. Examples of possible execution manners of process 1400 may include: continuous execution, returning to the beginning of the process and/or to Step 1420 once the process normal execution ends; periodically execution, executing the process at selected times; execution upon the detection of a trigger, where examples of such trigger may include a trigger from a user, a trigger from another process, etc.; any combination of the above; and so forth.

In some embodiments, identifying speakers (Step 1420) may comprise obtaining identifying information associated with one or more speakers, for example by a processing unit, such as processing units 430. In some examples, identifying speakers (Step 1420) may identify the name of one or more speakers, for example by accessing a database that comprises names and identifying audible and/or visual features. In some examples, identifying speakers (Step 1420) may identify demographic information associated with one or more speakers, such as age, sex, and so forth.

In some embodiments, identifying speakers (Step 1420) may comprise analyzing the audio data and/or the preprocessed audio data to identify one or more speakers and/or to identify information associated with one or more speakers, for example using speaker recognition algorithms. Some examples of such speaker recognition algorithms may include: pattern recognition algorithms; hidden Markov models based algorithms; mixture of Gaussians based algorithms; pattern matching based algorithms; neural networks based algorithms; quantization based algorithms; machine learning and/or deep learning based algorithms; and so forth. In some embodiments, identifying speakers (Step 1420) may comprise analyzing the audio data and/or the preprocessed audio data using one or more rules to determine demographic information associated with one or more speakers, such as age, sex, and so forth. In some examples, at least part of the one or more rules may be stored in a memory unit, such as memory units 420, shared memory modules 620, etc., and the rules may be obtained by accessing the memory unit and reading the rules. In some examples, at least part of the one or more rules may be preprogrammed manually. In some examples, at least part of the one or more rules may be the result of training algorithms, such as machine learning algorithms and/or deep learning algorithms, on training examples. The training examples may include examples of data instances, and in some cases, each data instance may be labeled with a corresponding desired label and/or result. For example, the training examples may include audio samples that contain speech, and be labeled according to the age and/or sex of the speaker. In some embodiments, the determining demographic information may be based, at least in part, on the output of one or more neural networks.

In some embodiments, identifying speakers (Step 1420) may comprise analyzing the visual data, such as visual data captured using image sensor 471, to detect one or more speakers and/or to identify one or more speakers and/or to identify information associated with one or more speakers, for example using lips movement detection algorithms, face recognition algorithms, and so forth.

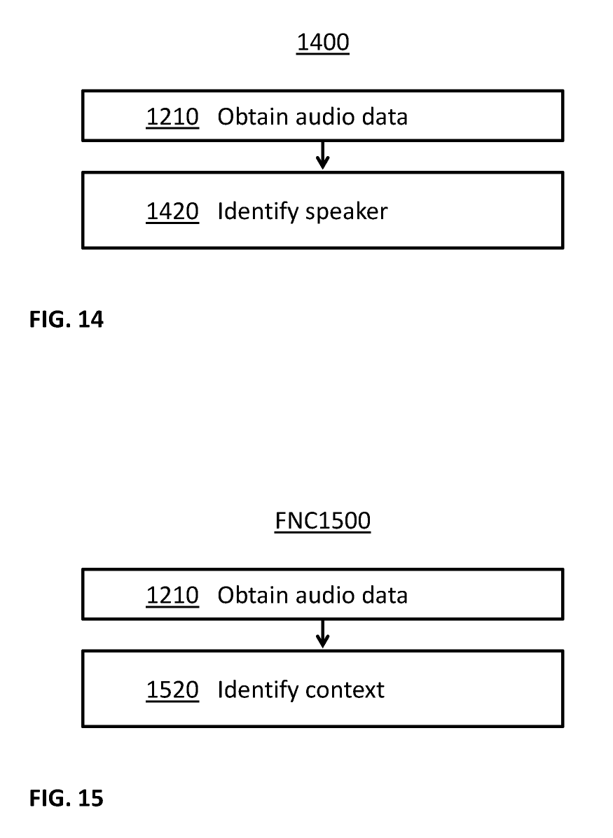

FIG. 15 illustrates an example of a process 1500 for identifying context. In some examples, process 1500, as well as all individual steps therein, may be performed by various aspects of: apparatus 400; server 500; cloud platform 600; computational node 610; and so forth. For example, process 1500 may be performed by processing units 430, executing software instructions stored within memory units 420 and/or within shared memory modules 620. In this example, process 1500 may comprise: obtaining audio data (Step 1210); and identifying context (Step 1520). In some implementations, process 1500 may comprise one or more additional steps, while some of the steps listed above may be modified or excluded. For example, Step 1210 may be excluded from process 1500. In some implementations, one or more steps illustrated in FIG. 15 may be executed in a different order and/or one or more groups of steps may be executed simultaneously and vice versa. For example, Step 1520 may be executed after and/or simultaneously with Step 1210. Examples of possible execution manners of process 1500 may include: continuous execution, returning to the beginning of the process and/or to Step 1520 once the process normal execution ends; periodically execution, executing the process at selected times; execution upon the detection of a trigger, where examples of such trigger may include a trigger from a user, a trigger from another process, etc.; any combination of the above; and so forth.

In some embodiments, identifying context (Step 1520) may comprise obtaining context information, for example by a processing unit, such as processing units 430. For example, identifying context (Step 1520) may comprise analyzing input data using one or more rules to identify context information and/or parameters of the context information. For example, the input data may include one or more of: audio data; preprocessed audio data; textual information; visual data, such as visual data captured using image sensor 471; physiological data; preprocessed physiological data; positioning data; preprocessed positioning data; motion data; preprocessed motion data; user input; and so forth. In some examples, at least part of the one or more rules may be stored in a memory unit, such as memory units 420, shared memory modules 620, etc., and the rules may be obtained by accessing the memory unit and reading the rules. In some examples, at least part of the one or more rules may be preprogrammed manually. In some examples, at least part of the one or more rules may be the result of training algorithms, such as machine learning algorithms and/or deep learning algorithms, on training examples. The training examples may include examples of input data instances, and in some cases, each input data instance may be labeled with a corresponding desired label and/or result, such as desired context information and/or desired parameters of the context information. In some embodiments, the identification of the context information and/or parameters of the context information may be based, at least in part, on the output of one or more neural networks. In some embodiments, prototypes may be used, the most similar prototype to the input data may be selected, and the context information and/or parameters of the context information may be based, at least in part, on the selected prototype. For example, prototypes may be generated manually. In another example, prototypes may be generated by clustering input data examples, and the centroids of the clusters may be used as prototypes.

In some embodiments, identifying context (Step 1520) may comprise analyzing the audio data and/or the preprocessed audio data to identify at least part of the context information. In some examples, identifying context (Step 1520) may comprise: analyzing the audio data and/or the preprocessed audio data to obtain textual information, for example using process 1200 and/or Step 1220; and analyzing of the textual information to identify context information and/or parameters of the context information. For example, the textual information may comprise a transcription of at least part of the audio data, and natural language processing algorithms may be used to determine context information and/or parameters of the context information. In another example, the textual information may comprise keywords, and the context information and/or parameters of the context information may be determined based on the keywords.

In some embodiments, identifying context (Step 1520) may comprise analyzing visual data, such as visual data captured using image sensor 471, to identify at least part of the context information. For example, the visual data may be analyzed to identify scene information, for example using visual scene recognition algorithms, and the context information and/or parameters of the context information may be based, at least in part, on the scene information. For example, the visual data may be analyzed to identify one or more persons in the environment and/or demographic information related to the one or more persons, for example using face detection and/or face recognition algorithms and/or process 1400 and/or Step 1420, and the context information and/or parameters of the context information may be based, at least in part, on the identity of the one or more persons and/or the demographic information related to the one or more persons. For example, the visual data may be analyzed to detect one or more objects in the environment and/or information related to the one or more objects, for example using object detection algorithms, and the context information and/or parameters of the context information may be based, at least in part, on the detected one or more objects and/or the information related to the one or more objects. For example, the visual data may be analyzed to detect one or more activities in the environment and/or information related to the one or more activities, for example using activity detection algorithms, and the context information and/or parameters of the context information may be based, at least in part, on the detected one or more activities and/or the information related to the one or more activities. For example, the visual data may be analyzed to identify text in the environment, for example using optical character recognition algorithms, and the context information and/or parameters of the context information may be based, at least in part, on the identified text.

In some embodiments, identifying context (Step 1520) may comprise determining the context information and/or parameters of the context information based, at least in part, on conversations or information related to conversations, such as the conversations identified using process 1300 and/or Step 1320. In some examples, context information and/or parameters of the context information may be based, at least in part, on properties of the identified conversations, such as the length of the conversation, the number of participants in the conversation, the identity of one or more participants, the topics of the conversation, keywords from the conversation, and so forth. In some embodiments, identifying context (Step 1520) may comprise determining the context information and/or parameters of the context information based, at least in part, on identifying information associated with one or more speakers, such as identifying information associated with one or more speakers obtained using process 1400 and/or Step 1420.

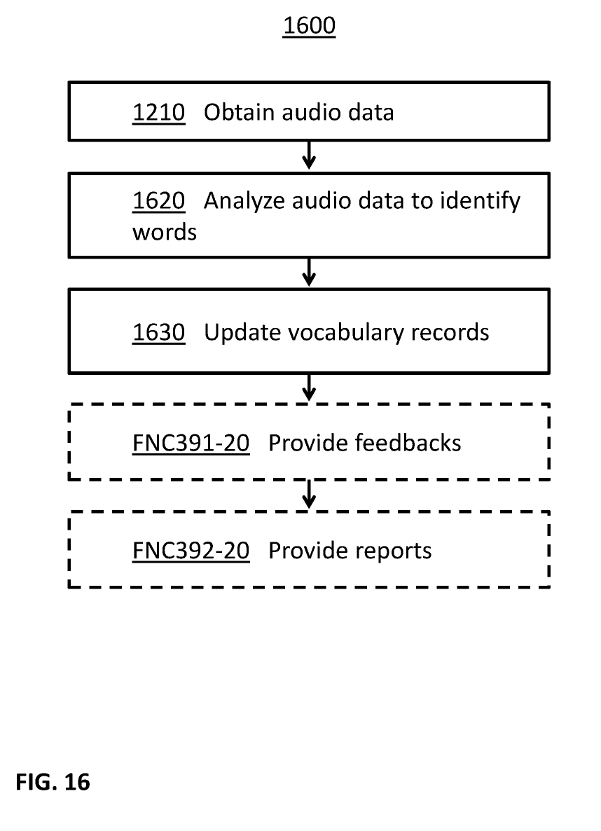

FIG. 16 illustrates an example of a process 1600 for analyzing audio to update vocabulary records. In some examples, process 1600, as well as all individual steps therein, may be performed by various aspects of: apparatus 400; server 500; cloud platform 600; computational node 610; and so forth. For example, process 1600 may be performed by processing units 430, executing software instructions stored within memory units 420 and/or within shared memory modules 620. In this example, process 1600 may comprise: obtaining audio data (Step 1210); analyzing audio data to identify words (Step 1620); and updating vocabulary records (Step 1630). In some implementations, process 1600 may comprise one or more additional steps, while some of the steps listed above may be modified or excluded. For example, Step 1210 and/or Step 1630 may be excluded from process 1600. For example, process 1600 may also comprise one or more of the following steps: providing feedbacks (Step 1640), providing reports (Step 1650). In some implementations, one or more steps illustrated in FIG. 16 may be executed in a different order and/or one or more groups of steps may be executed simultaneously and vice versa. For example, Step 1620 and/or Step 1630 may be executed after and/or simultaneously with Step 1210. For example, Step 1210 and/or Step 1620 may be executed before and/or simultaneously with Step 1630. For example, Step 1640 and/or Step 1650 may be executed after and/or simultaneously with Step 1610 and/or Step 1620 and/or Step 1630. Examples of possible execution manners of process 1600 may include: continuous execution, returning to the beginning of the process and/or to any step within the process once the process normal execution ends; periodically execution, executing the process at selected times; execution upon the detection of a trigger, where examples of such trigger may include a trigger from a user, a trigger from another process, etc.; any combination of the above; and so forth.

In some embodiments, analyzing audio data to identify words (Step 1620) may comprise analyzing the audio data and/or the preprocessed audio data to identify one or more words, for example by a processing unit, such as processing units 430. In some examples, the one or more words may be associated with the entire audio data. In some examples, the one or more words may be associated with a group of one or more portions of the audio data, for example, a group of one or more portions of the audio data that were identified as associated with: a given speaker, such as the wearer, a person engaged in a conversation with the wearer, etc.; given locations; given regions; given time frames; a given context; conversations with given speakers; conversations regarding given topics; any combination of the above; and so forth. In some examples, the identified one or more words may comprise words present in the audio data. In some examples, the identified one or more words may comprise lemmas of words present in the audio data. In some examples, the identified one or more words may comprise word families of words present in the audio data.

In some embodiments, analyzing audio data to identify words (Step 1620) may comprise analyzing the audio data and/or the preprocessed audio data to identify one or more words associated with a selected speaker, such as the wearer, a person engaged in a conversation with the wearer, and so forth. For example, speech may be identified as associated with a speaker using: pattern recognition algorithms; hidden Markov models based algorithms; mixture of Gaussians based algorithms; pattern matching based algorithms; neural networks based algorithms; quantization based algorithms; machine learning and/or deep learning based algorithms; and so forth. The one or more words may be identified based on speech associated with a desired speaker. For example, analyzing audio data to identify words (Step 1620) may comprise analyzing the audio data and/or the preprocessed audio data to identify one or more words spoken by the wearer.

In some embodiments, analyzing audio data to identify words (Step 1620) may comprise: analyzing the audio data and/or the preprocessed audio data to obtain textual information, for example using process 1200 and/or Step 1220; and analyzing the obtained textual information to identify the one or more words. For example, the textual information may be analyzed, for example using natural language processing algorithms, to identify topics and/or keywords in the textual information, and the identified one or more words may comprise the keywords and/or words describing the identified topics. In another example, the identified one or more words may comprise words contained in the textual information.

In some embodiments, one or more vocabulary records may be maintained, for example in a memory unit, such as memory units 420, shared memory modules 620, and so forth. For example, one or more vocabulary records may be maintained as a log file, as a database, as a data-structure, as a container data-structure, and so forth. In some examples, at least part of the vocabulary records may be associated with speakers, such as the wearer, a person engaged in a conversation with the wearer, and so forth. In some embodiments, a vocabulary record may comprise information associated with one or more words, for example a list of words used by a speaker associated with the vocabulary record. For example, the information associated with one or more words may comprise the one or more words, lemmas of the one or more words, word families of the one or more words, words describing topics discussed by the speaker, and so forth. In some examples, words in the vocabulary record may be accompanied by contextual information, for example by other words commonly used in conjunction with the words. In some examples, words in the vocabulary record may be accompanied by frequencies, for example by the frequencies at which the speaker associated with the vocabulary record use the words. In some examples, words in the vocabulary record may be accompanied by usage information, for example by the times and/or conversations and/or contextual situations at which the speaker associated with the vocabulary record use the words. For example, the contextual situations may be determined using process 1500 and/or Step 1520.

In some embodiments, updating vocabulary records (Step 1630) may comprise updating one or more vocabulary records, for example based on the one or more words identified by Step 1620, for example by a processing unit, such as processing units 430. In some examples, the vocabulary record to be updated may be selected from one or more vocabulary records stored in a memory unit, such as memory units 420, shared memory modules 620, and so forth. For example, the selection of the vocabulary record to be updated may be based on at least one of: the one or more words; identity of speaker of the one or more words; identity of speakers engaged in conversation with the speaker of the one or more words; topic of the conversation; geographical location associated with the one or more words; time associated with the one or more words; speech prosody associated with the one or more words; context information, such as the context information obtained using process 1500 and/or Step 1520; context information associated with the one or more words; any combination of the above; and so forth.

In some examples, a vocabulary record may comprise a list of words, and updating vocabulary records (Step 1630) may comprise adding at least part of the one or more words identified by Step 1620 to the list of words. In some examples, vocabulary record may comprise a counter for each word, and updating vocabulary records (Step 1630) may comprise increasing the counters associated with the one or more words identified by Step 1620. In some examples, vocabulary record may comprise contextual information records for words, and updating vocabulary records (Step 1630) may comprise updating the contextual information records associated with the one or more words identified by Step 1620 according to contextual information associated with the one or more words, for example based on the context information obtained using process 1500 and/or Step 1520. For example, contextual information may comprise information associated with at least one of: identity of speaker of the one or more words; identity of speakers engaged in conversation with the speaker of the one or more words; topic of the conversation; geographical location associated with the one or more words; time associated with the one or more words; speech prosody associated with the one or more words; and so forth. In some examples, vocabulary records may comprise word co-occurrence information for each word, and updating vocabulary records (Step 1630) may comprise updating the word co-occurrence information according to words that were identified in the audio data in conjunction to the one or more words. In some examples, vocabulary records may comprise information related to the type of words, such as pronouns, nouns, verbs, descriptors, possessives, negatives, demonstratives, question word, and so forth.

In some embodiments, at least two of the one or more vocabulary records may be compared to one another. For example, a vocabulary record associated with a first speaker may be compared to a vocabulary record associated with a second speaker. For example, a vocabulary record associated with the wearer may be compared to a vocabulary record associated with a person engaged in conversation with the wearer. In another example, a vocabulary record associated with a first time frame may be compared to a vocabulary record associated with a second time frame. In an additional example, a vocabulary record associated with a first geographical region may be compared to a vocabulary record associated with a second geographical region. In another example, a vocabulary record associated with a first context may be compared to a vocabulary record associated with a second context. In an additional example, a vocabulary record associated with conversations regarding a first group of topics may be compared to a vocabulary record associated with conversations regarding a second group of topics. In another example, a vocabulary record associated with conversations with speakers of a first group of speakers may be compared to a vocabulary record associated with conversations with speakers of a second group of speakers. And so forth.

In some embodiments, providing feedbacks (Step 1640) may comprise providing one or more feedbacks to one or more users. In some examples, feedback may be provided upon a detection of: an event; an event that matches certain criterions; an event associated with properties that match certain criterions; an assessment result that match certain criterions; an item or object that matches certain criterions; an item or object associated with properties that matches certain criterions; and so forth. In some examples, the nature and/or content of the feedback may depend on: the detected event; the identified properties of the detected event; the detected item; the identified properties of the detected item; the detected object; the identified properties of the detected object; and so forth. In some examples, such events, items and/or objects may be detected by a processing unit, such as processing units 430.

In some embodiments, after providing a first feedback, additional events may be identified. In such cases, providing feedbacks (Step 1640) may comprise providing additional feedbacks upon the detection of the additional events. For example, the additional feedbacks may be provided in a similar fashion to the first feedback. In some examples, the system may avoid providing additional similar feedbacks for selected time duration. In some examples, the additional feedback may be identical to the previous feedback. In some examples, the additional feedback may differ from the previous feedback, for example by being of increased intensity, by mentioning the previous feedback, and so forth.

In some embodiments, providing feedbacks (Step 1640) may comprise providing one or more feedbacks to one or more users. In some examples, feedbacks may be provided upon the identification of a trigger. In some examples, the nature of the feedback may depend on information associated with the trigger, such as the type of the trigger, properties of the identified trigger, and so forth. Examples of such triggers may include: voice commands, such as voice commands captured using audio sensors 460; press of a button; hand gestures, such as hand gestures captured using image sensors 471; and so forth. In some examples, such triggers may be identified by a processing unit, such as processing units 430.

In some embodiments, providing feedbacks (Step 1640) may comprise providing one or more feedbacks as a: visual output, for example using visual outputting units 452; audio output, for example using audio output units 451; tactile output, for example using tactile outputting units 453; electric current output; any combination of the above; and so forth. In some examples, the amount of feedbacks, the events triggering feedbacks, the content of the feedbacks, the nature of the feedbacks, etc., may be controlled by configuration. The feedbacks may be provided: by the apparatus detecting the events; through another apparatus; and so forth. In some examples, the feedbacks may be provided by a wearable apparatus, such as a wearable version of wearable apparatus 400. The feedbacks provided by the wearable apparatus may be provided to: the wearer of the wearable apparatus; one or more caregivers of the wearer of the wearable apparatus; any combination of the above; and so forth.

In some embodiments, providing feedbacks (Step 1640) may comprise providing one or more feedbacks based, at least in part, on one or more words, such as the words identified by Step 1620, and/or on one or more vocabulary records, such as the vocabulary records maintained by Step 1630. In some examples, at least one of the words identified by Step 1620 may be selected, for example based on at least one vocabulary record, and the feedback may comprise an interpretation of the selected word. For example, a word spoken by a person engaged in conversation with the wearer may be selected when the word is not included in a vocabulary record associated with the wearer, and an interpretation of that word may be provided. In some examples, at least one of the words identified by Step 1620 may be selected, for example based on at least one vocabulary record, and the feedback may comprise a synonym of the selected word. For example, a word spoken by the wearer may be selected, and a synonym included in a vocabulary record may be provided. In some examples, at least one of the words identified by Step 1620 may be selected, for example based on at least one vocabulary record, and the feedback may comprise information associated with that word. For example, the feedback may include trivia details associated with the selected word. In some examples, the feedbacks may be based on information related to the type of at least one of the one or more words. Some examples of such types may include: pronouns, nouns, verbs, descriptors, possessives, negatives, demonstratives, question word, and so forth. In some examples, the feedbacks may include suggested a usage of a word, a phrase, a sentence, and so forth. In some example, the feedback may include a suggestion of a correct form and/or correct usage of a word, a phrase, a sentence, and so forth.

In some embodiments, providing reports (Step 1650) may comprise generating and/or providing one or more reports to one or more users. For example, information may be aggregated, including information related to: detected events; assessment results; identified objects; identified items; and so forth. The information may be aggregated by a processing unit, such as processing units 430. The aggregated information may be stored in a memory unit, such as memory units 420, shared memory modules 620, and so forth. Some examples of such aggregated information may include: a log of detected events, objects, and/or items, possibly together identified properties of the detected events, objects and/or items; statistics related to the detected events, objects, and/or items; statistics related to the identified properties of the detected events, objects, and/or items; one or more vocabulary records, such as the vocabulary records maintained by Step 1630; and so forth. In some embodiments, providing reports (Step 1650) may comprise generating and/or providing one or more reports based on the aggregated information, for example by a processing unit, such as processing units 430. In some examples, the report may comprise: all or part of the aggregated information; a summary of the aggregated information; information derived from the aggregated information; statistics based on the aggregated information; and so forth. In some examples, the reports may include a comparison of the aggregated information to: past information, such as past performance information; goals; normal range values; and so forth.

In some embodiments, providing reports (Step 1650) may comprise providing one or more reports: in a printed form, for example using one or more printers; audibly read, for example using audio outputting units 451; visually displayed, for example using visual outputting units 452; and so forth. In some examples, the reports may be provided by or in conjunction with a wearable apparatus, such as a wearable version of apparatus 400. The generated reports may be provided to: the wearer of the wearable apparatus; one or more caregivers of the wearer of the wearable apparatus; any combination of the above; and so forth.

In some embodiments, providing reports (Step 1650) may comprise generating and/or providing one or more reports based, at least in part, on one or more words, such as the words identified by Step 1620, and/or on one or more vocabulary records, such as the vocabulary records maintained by Step 1630. For example, the report may comprise at least part of the details included in at least one vocabulary record and/or information inferred from the at least one vocabulary record, such as words, lemmas, word families, topics, frequency of usage of any of the above, contextual information associated with any of the above, and so forth. In some examples, the reports may comprise information related to the type of at least some of the words in a vocabulary record. Some examples of such types may include: as pronouns, nouns, verbs, descriptors, possessives, negatives, demonstratives, question word, and so forth. In some examples, the reports may include a score and/or information related to the usage of grammatical markers. In some examples, the reports may include a comparison of a speaker with other speakers, such as speakers of an age range.

In some examples, the at least one vocabulary record may be selected from one or more vocabulary records stored in a memory unit, such as memory units 420 and/or shared memory modules 620, and the reports may comprise information from the vocabulary record. In some examples, the reports may comprise a comparison of the vocabulary record to at least one of: past vocabulary records; goals; normal range values; and so forth. For example, the report may comprise at least one of: a comparison of the size of two vocabularies; a comparison of the size of a vocabulary to a goal size; a comparison of the size of a vocabulary to a normal range value according to speaker age; and so forth. In some cases, the reports may comprise comparisons of at least two of the one or more vocabulary records to one another, such as the comparisons described above. In some cases, the reports may comprise suggestions of new words to be used by the speaker. For example, the suggestions of new words may comprise words that are not used by the speaker according to the vocabulary record, but are related to the conversation topics of the conversations the speaker is engaged in.

In some embodiments, the system may obtain audio data, for example using process 800 and/or Step 810 and/or Step 1210. The system may analyze the audio data and/or the preprocessed audio data to identify one or more words associated with the wearer, for example using process 1600 and/or Step 1620. For example, the one or more words may comprise one or more words spoken by the wearer. The system may maintain in one or more vocabulary records stored in a memory unit, such as memory units 420, shared memory modules 620. The system may update at least one of the one or more vocabulary records based on the identified one or more words, for example using process 1600 and/or Step 1630. In some examples, the system may provide one or more feedbacks, for example using process 1600 and/or Step 1640. The feedbacks may be based on the identified one or more words and/or the maintained one or more vocabulary records. In some examples, the system may provide one or more reports, for example using process 1600 and/or Step 1650. The reports may be based on the identified one or more words and/or the maintained one or more vocabulary records. In some examples, the system may identify a second group one or more words associated with a second speaker, for example using process 1600 and/or Step 1620. For example, the second speaker may be a speaker that the system identified as a speaker engaged in conversation with the wearer, for example using process 1300 and/or Step 1320. For example, the one or more words may comprise one or more words spoken by the second speaker. The system may select at least one of the one or more maintained vocabulary records, for example by selecting a vocabulary record that is associated with the second speaker. The system may update the selected vocabulary record based on the identified second group of one or more words, for example using process 1600 and/or Step 1630. In some examples, the system may assess at least one vocabulary record according to at least one other vocabulary records, for example by comparing the content and/or size of the vocabulary records. For example, the system may assess at least one vocabulary record associated with the wearer according to at least one vocabulary records associated with another speaker, with a group of speakers, with a normally expected vocabulary record, and so forth.

It will also be understood that the system according to the invention may be a suitably programmed computer, the computer including at least a processing unit and a memory unit. For example, the computer program can be loaded onto the memory unit and can be executed by the processing unit. Likewise, the invention contemplates a computer program being readable by a computer for executing the method of the invention. The invention further contemplates a machine-readable memory tangibly embodying a program of instructions executable by the machine for executing the method of the invention.

What is claimed is:

1. A system for processing audio, the system comprising:
one or more memory units configured to store one or more vocabulary records; and
at least one processing unit configured to:
obtain audio data captured by one or more wearable audio sensors included in a wearable apparatus;
analyze the audio data to identify one or more words associated with a wearer of the wearable apparatus; and
based on the identified one or more words, update at least one of the one or more vocabulary records.

2. The system of claim 1, wherein the identified one or more words comprises one or more words spoken by the wearer.

3. The system of claim 1, wherein the at least one processing unit is further configured to:
analyze the audio data to identify a context; and
select the at least one of the one or more vocabulary records of the one or more vocabulary records based on the context.

4. The system of claim 3, wherein the context is associated with at least one of: a keyword, a conversation topic and a conversation partner.

5. The system of claim 1, wherein the at least one processing unit is further configured to:
provide one or more reports to a user based on at least one of the one or more vocabulary records.

6. The system of claim 1, wherein the system includes the wearable apparatus; obtaining the audio data comprises capturing the audio data from an environment of the wearer; and wherein the at least one processing unit is further configured to:
provide feedback to the wearer based on at least one of the one or more vocabulary records and on the identified one or more words.

7. The system of claim 6, wherein the feedback comprises an interpretation of at least one of the identified one or more words.

8. The system of claim 6, wherein the feedback comprises a suggestion for at least one new word.

9. The system of claim 1, wherein the at least one processing unit is further configured to:
analyze the audio data to identify a second group of one or more words associated with a second speaker;
select at least one vocabulary record associated with the second speaker of the one or more vocabulary records; and
based on the second group of one or more words, update the selected at least one vocabulary record associated with the second speaker.

10. The system of claim 9, wherein the at least one processing unit is further configured to:
determine that the first speaker and the second speaker are engaged in a conversation.

11. The system of claim 9, wherein the at least one processing unit is further configured to:
assess at least one vocabulary record associated with the wearer according to the selected at least one vocabulary record associated with the second speaker.

12. A method for processing audio, the method comprising:
obtaining audio data captured by one or more audio sensors included in a wearable apparatus;
analyzing the audio data to identify one or more words associated with a wearer of the wearable apparatus; and
based on the identified one or more words, updating at least one vocabulary record.

13. The method of claim 12, wherein the identified one or more words comprises one or more words spoken by the wearer.

14. The method of claim 12, further comprising:
analyzing the audio data to identify a context; and
selecting the at least one vocabulary record of a plurality of vocabulary records based on the context.

15. The method of claim 14, wherein the context is associated with at least one of: a keyword, a conversation topic and a conversation partner.

16. The method of claim 12, further comprising:
providing one or more reports to a user based on the at least one vocabulary record.

17. The method of claim 12, wherein obtaining the audio data comprises capturing the audio data from an environment of the wearer; and wherein the method further comprising:
providing feedback to the wearer based on the at least one vocabulary record and on the identified one or more words.

18. The method of claim 17, wherein the feedback comprises an interpretation of at least one of the identified one or more words.

19. The method of claim 17, wherein the feedback comprises a suggestion for at least one new word.

20. The method of claim 12, further comprising:
analyzing the audio data to identify a second group of one or more words associated with a second speaker; and
selecting at least one vocabulary record associated with the second speaker of a plurality of vocabulary records; and
based on the second group of one or more words, updating the selected at least one vocabulary record associated with the second speaker.

21. The method of claim 20, further comprising:
determining that the first speaker and the second speaker are engaged in a conversation.

22. The method of claim 20, further comprising:
assessing at least one vocabulary record associated with the wearer according to the selected at least one vocabulary record associated with the second speaker.

23. A software product stored on a non-transitory computer readable medium and comprising data and computer implementable instructions for carrying out the method of claim 12.
